(19) United States
(12) Patent Application Publication
(10) Pub. No.: US 2026/0106714 A1
(43) Pub. Date: Apr. 16, 2026

(54) DOWNLINK ANTENNA AUGMENTATION USING SIDELINK AND COMPANION DEVICES

(71) Applicant: QUALCOMM Incorporated, San Diego, CA (US)

(72) Inventors: Alexander SVERDLOV, Rehovot (IL); Michael LEVITSKY, Rehovot (IL); Daniel PAZ, Atlit (IL); Gideon Shlomo KUTZ, Ramat Hasharon (IL); Amit BAR-OR TILLINGER, Tel-Aviv (IL); Assaf TOUBOUL, Netanya (IL)

(21) Appl. No.: 18/916,313

(22) Filed: Oct. 15, 2024

(51) Int. Cl. H04L 5/00; H04L 25/02; H04W 92/18

(52) U.S. Cl. CPC H04L 5/0051; H04L 25/0204; H04W 92/18

(57) ABSTRACT

Various aspects of the present disclosure generally relate to wireless communication. In some aspects, a receiver user equipment (UE) may receive, from a network node via an access link, a first set of one or more signals including at least one instance of a data set. The UE may receive, from a transmitter wireless device via a sidelink, a second set of one or more signals including a plurality of repetitions of the data set and including a set of one or more respective sidelink reference signals corresponding to the plurality of repetitions of the data set. The UE may perform a data processing procedure, according to the set of one or more respective sidelink reference signals, on the first set of one or more signals and the second set of one or more signals to generate the data set. Numerous other aspects are described.

### FIELD OF THE DISCLOSURE

Aspects of the present disclosure generally relate to wireless communication and specifically relate to techniques, apparatuses, and methods associated with downlink antenna augmentation using sidelink and companion devices.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IOT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to an apparatus for wireless communication at a receiver user equipment (UE). The apparatus may include one or more memories and one or more processors coupled to the one or more memories. The one or more processors may be configured, individually or in any combination, to receive, from a network node via an access link, a first set of one or more signals including at least one instance of a data set. The one or more processors may be configured, individually or in any combination, to receive, from a transmitter wireless device via a sidelink, a second set of one or more signals including a plurality of repetitions of the data set and including a set of one or more respective sidelink reference signals corresponding to the plurality of repetitions of the data set. The one or more processors may be configured, individually or in any combination, to perform a data processing procedure, according to the set of one or more respective sidelink reference signals, on the first set of one or more signals and the second set of one or more signals to generate the data set.

Some aspects described herein relate to an apparatus for wireless communication at a transmitter wireless device. The apparatus may include one or more memories and one or more processors coupled to the one or more memories. The one or more processors may be configured, individually or in any combination, to receive, from a network node via an access link, a first set of one or more signals including at least one instance of a data set intended for a receiver UE. The one or more processors may be configured, individually or in any combination, to generate a plurality of repetitions of the data set in association with scaling the data set according to one or more parameters associated with a sidelink between the receiver UE and the transmitter wireless device. The one or more processors may be configured, individually or in any combination, to transmit, to the receiver UE via the sidelink, a second set of one or more signals including the plurality of repetitions of the data set and including a set of one or more respective sidelink reference signals corresponding to the plurality of repetitions of the data set.

Some aspects described herein relate to a method of wireless communication performed by a receiver UE. The method may include receiving, from a network node via an access link, a first set of one or more signals including at least one instance of a data set. The method may include receiving, from a transmitter wireless device via a sidelink, a second set of one or more signals including a plurality of repetitions of the data set and including a set of one or more respective sidelink reference signals corresponding to the plurality of repetitions of the data set. The method may include performing a data processing procedure, according to the set of one or more respective sidelink reference signals, on the first set of one or more signals and the second set of one or more signals to generate the data set.

Some aspects described herein relate to a method of wireless communication performed by a transmitter wireless device. The method may include receiving, from a network node via an access link, a first set of one or more signals including at least one instance of a data set intended for a receiver UE. The method may include generating a plurality of repetitions of the data set in association with scaling the data set according to one or more parameters associated with a sidelink between the receiver UE and the transmitter wireless device. The method may include transmitting, to the receiver UE via the sidelink, a second set of one or more signals including the plurality of repetitions of the data set and including a set of one or more respective sidelink reference signals corresponding to the plurality of repetitions of the data set.

Some aspects described herein relate to a non-transitory computer-readable medium that stores a set of instructions for wireless communication by a receiver UE. The set of instructions, when executed by one or more processors of the UE, may cause the UE to receive, from a network node via an access link, a first set of one or more signals including at least one instance of a data set. The set of instructions, when executed by one or more processors of the UE, may cause the UE to receive, from a transmitter wireless device via a sidelink, a second set of one or more signals including a plurality of repetitions of the data set and including a set of one or more respective sidelink reference signals corresponding to the plurality of repetitions of the data set. The set of instructions, when executed by one or more processors of the UE, may cause the UE to perform a data processing procedure, according to the set of one or more respective sidelink reference signals, on the first set of one or more signals and the second set of one or more signals to generate the data set.

Some aspects described herein relate to a non-transitory computer-readable medium that stores a set of instructions for wireless communication by a transmitter wireless device. The set of instructions, when executed by one or more processors of the transmitter wireless device, may cause the transmitter wireless device to receive, from a network node via an access link, a first set of one or more signals including at least one instance of a data set intended for a receiver UE. The set of instructions, when executed by one or more processors of the transmitter wireless device, may cause the transmitter wireless device to generate a plurality of repetitions of the data set in association with scaling the data set according to one or more parameters associated with a sidelink between the receiver UE and the transmitter wireless device. The set of instructions, when executed by one or more processors of the transmitter wireless device, may cause the transmitter wireless device to transmit, to the receiver UE via the sidelink, a second set of one or more signals including the plurality of repetitions of the data set and including a set of one or more respective sidelink reference signals corresponding to the plurality of repetitions of the data set.

Some aspects described herein relate to an apparatus for wireless communication. The apparatus may include means for receiving, from a network node via an access link, a first set of one or more signals including at least one instance of a data set. The apparatus may include means for receiving, from a transmitter wireless device via a sidelink, a second set of one or more signals including a plurality of repetitions of the data set and including a set of one or more respective sidelink reference signals corresponding to the plurality of repetitions of the data set. The apparatus may include means for performing a data processing procedure, according to the set of one or more respective sidelink reference signals, on the first set of one or more signals and the second set of one or more signals to generate the data set.

Some aspects described herein relate to an apparatus for wireless communication. The apparatus may include means for receiving, from a network node via an access link, a first set of one or more signals including at least one instance of a data set intended for a receiver UE, means for generating a plurality of repetitions of the data set in association with scaling the data set according to one or more parameters associated with a sidelink between the receiver UE and the transmitter wireless device. The apparatus may include means for transmitting, to the receiver UE via the sidelink, a second set of one or more signals including the plurality of repetitions of the data set and including a set of one or more respective sidelink reference signals corresponding to the plurality of repetitions of the data set.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of a relay user equipment (UE) that relays communications between a UE and a network node, in accordance with the present disclosure.

FIG. 6 is a diagram illustrating an example of a transmit chain and a receive chain of a UE, in accordance with the present disclosure.

FIG. 7 is a diagram of an example associated with downlink antenna augmentation using sidelink and companion devices, in accordance with the present disclosure.

FIG. 8A is a diagram illustrating an example associated with sidelink reception/transmission processing, in accordance with the present disclosure.

FIG. 8B is a diagram illustrating an example associated with a repetition scheme associated with sidelink reception/transmission processing, in accordance with the present disclosure.

FIG. 9 is a diagram illustrating an example associated with sidelink reception processing, in accordance with the present disclosure.

FIG. 10 is a diagram illustrating an example associated with sidelink communications, in accordance with the present disclosure.

FIG. 11 is a diagram illustrating an example process performed, for example, at a UE or an apparatus of a UE, in accordance with the present disclosure.

FIG. 12 is a diagram illustrating an example process performed, for example, at a transmitter wireless device or an apparatus of a transmitter wireless device, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Some wireless communications systems may support device-to-device (D2D) communications. For example, a first user equipment (UE) and a second UE may communicate directly with one another using sidelink communications (for example, independently of a network node as an intermediary). As an example, the first UE may directly transmit data, control information, or other signaling as a sidelink communication to the second UE. In some deployments and configurations, a network node may schedule and/or allocate resources for sidelink communications between UEs. In some other deployments and configurations, a UE may perform, or collaborate or negotiate with one or more other UEs to perform, scheduling operations, resource selection operations, and/or other operations for sidelink communications. Sidelink data and control transmissions may use sidelink-specific channels such as a physical sidelink shared channel (PSSCH), a physical sidelink control channel (PSCCH), and/or a physical sidelink feedback channel (PSFCH).

Some wireless communications systems may support ultrawide bandwidth (UWB)-compliant sidelink, and/or licensed-band-compliant sidelink communications, such as FR2 band sidelink communications and/or FR3 band sidelink communications. UWB communications, FR2 communications, and/or FR3 communications may be more efficient, less affected by interference, and may be associated with greater power-saving benefits than some other technologies that may be applied to sidelink communications. UWB communications may be performed over a wide range of frequencies (e.g., ˜3.1 GHz to ˜10.6 GHZ). In comparison to narrowband communication systems that use a single frequency or a narrow band of frequencies, UWB supports communications over a broad spectrum of frequencies, thereby increasing throughput, at very low power levels.

Other frequency bands have been defined as frequency range designations FR1 (410 MHz through 7.125 GHZ), FR2 (24.25 GHz through 52.6 GHZ), and FR3 (7.125 GHz through 24.25 GHZ), among other examples. Although a portion of FR1 is greater than 6 GHZ, FR1 is often referred to (interchangeably) as a “sub-6 GHz” band. Similarly, FR2 is often referred to (interchangeably) as a “millimeter wave” band, despite being different than the extremely high frequency (EHF) band (30 GHz through 300 GHZ), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies.

UWB communications, FR2 communications, and/or FR3 communications may be used for communications between UEs and companion devices. Companion devices may include wearable UEs (e.g., fitness trackers, extended reality (XR) goggles and/or headsets, smartwatches, smart glasses, smart clothing, and/or personal medical monitors), smart home UEs, internet-of-things (IOT) devices, reduced capability (RedCap) UEs, and/or any other UE that supports or enhances the functionality of a primary UE. “Primary UE” refers to a main UE and/or a target UE that is performing a primary function (e.g., communicating, web browsing, messaging, system navigation, or any other interaction with a core functionality of the device) for a user and may be relative to the usage and type of interaction that the user has with the device.

UWB communications may be bounded by regulations, such as a minimum bandwidth usage (e.g., UWB communications may be performed via a bandwidth that is greater than or equal to the minimum bandwidth defined by UWB regulations), and/or a power spectral density (PSD) constraint. For example, any signal communicated via UWB may be communicated via a bandwidth that is equal to or greater than the minimum bandwidth (e.g., 500 MHz or greater), and/or a transmit power of the signal may be distributed over the bandwidth use (e.g., may not exceed the PSD constraint). However, bandwidth usage that is equal to or greater that the minimum bandwidth usage may foster high transmit power, high throughput communications when communicating some high-complexity, high transmit power waveforms, which may increase throughput and/or data rates but may incur high energy costs at sidelink receivers, and sidelink transmitters, consuming energy that is already limited for sidelink devices, including primary UEs and companion devices and potentially at odds with the PSD constraint.

Various aspects relate generally to capitalizing on the spectral bandwidth of UWB, FR2, and/or FR2 communications (e.g., to increase throughout and/or data rates), while decreasing a total transmit power by implementing a waveform for communications that is associated with low complexity and may be relatively short in the time domain through sidelink frequency domain data set repetition (e.g., to mitigate high energy costs). Some aspects more specifically relate to the companion device generating and transmitting, and the primary UE receiving, a plurality of repetitions of a data set intended for the primary UE from a network node via UWB, FR2, and/or FR3 communications. Some aspects more specifically relate to the primary UE combining the sidelink repetitions based on a channel estimation procedure using a set of sidelink reference signals. Some aspects more specifically relate to the primary UE receiving an instance of the data set from the network node. In some aspects, the primary UE may perform combined demodulation on the repetitions of the data set and the at least one instance of the data set. In some aspects, prior to transmitting the data set repetitions, the companion device may scale the data set over a frequency range that satisfies a bandwidth threshold associated with UWB, FR2, and/or FR2 communications.

Particular aspects of the subject matter described in this disclosure can be implemented to realize one or more of the following potential advantages. By the primary UE and/or the companion device communicating sidelink frequency domain data set repetitions, a power consumption of the primary UE and/or the companion device may be reduced by avoiding relatively high transmit powers that are otherwise needed to support the successful communication of a single signal repetition. In some examples, the described techniques can be used to augment data reception from the network node by sharing local received samples between sidelink devices via licensed (e.g., FR2/FR3) and/or unlicensed (e.g., UWB) high throughput sidelink technologies. By generating and transmitting a plurality of repetitions of the data set, the companion device may augment an antenna rank of the primary UE without incurring additional manufacturing costs. Thus, antenna augmentation may enhance data throughput (e.g., via antenna rank augmentation), increase coverage, and improve the effects of interference. By the companion device transmitting, and the primary UE receiving, a set of sidelink reference signals, the sidelink communications may benefit from increased robustness of the data set. For example, the companion device generating the repetitions using user specific scrambling and the primary UE performing repetition combining and/or combined demodulation using the sidelink reference signals may serve as an interference suppression mechanism between sidelink devices.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, IoT networks or RedCap device deployments, ultra-reliable low-latency communication (URLLC) applications, and/or massive machine-type communication (mMTC), among other examples.

Some UEs 120 may be considered machine-type communication (MTC) UEs, evolved or enhanced machine-type communication (eMTC) UEs, further enhanced eMTC (feMTC) UEs, or enhanced feMTC (efeMTC) UEs, or further evolutions thereof, all of which may be simply referred to as “MTC UEs.” For example, the UE 120d and/or the UE 120e may be an MTC UE. An MTC UE may be, may include, or may be included in or coupled with a robot, an uncrewed aerial vehicle, a remote device, a sensor, a meter, a monitor, and/or a location tag. Some UEs 120 may be considered IoT devices. Some such UEs 120 may be implemented as NB-IOT (narrowband IoT) devices, such as the UE 120d. An IoT or NB-IOT device may be, may include, or may be included in or coupled with an industrial machine, an appliance, a refrigerator, a doorbell camera device, a home automation device, and/or a light fixture, among other examples. Some UEs 120 may be considered Customer Premises Equipment (CPEs), which may include telecommunications devices that are installed at a customer location (such as a home or office) to enable access to a service provider's network (such as included in or in communication with the wireless communication network 100).

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, XR and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

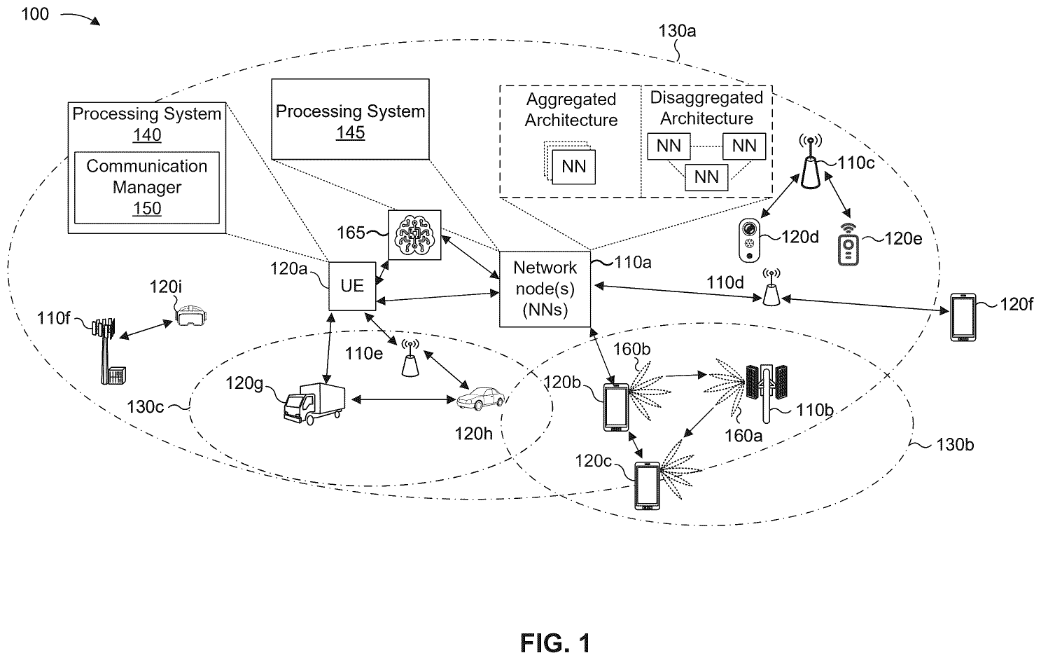

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a, a network node 110b, network node 110c, network node 110d, network node 110c, and a network node 110f. The network nodes 110 may support communications with multiple UEs 120. For example, in FIG. 1, the network nodes 110 support communication with a UE 120a, a UE 120b, a UE 120c, a UE 120d, a UE 120c, a UE 120f, a UE 120g, a UE 120h, and a UE 120i. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHZ), FR3 (7.125 GHz through 24.25 GHz), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles, despite being different than the EHF band (30 GHz through 300 GHZ), which is identified by the ITU as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

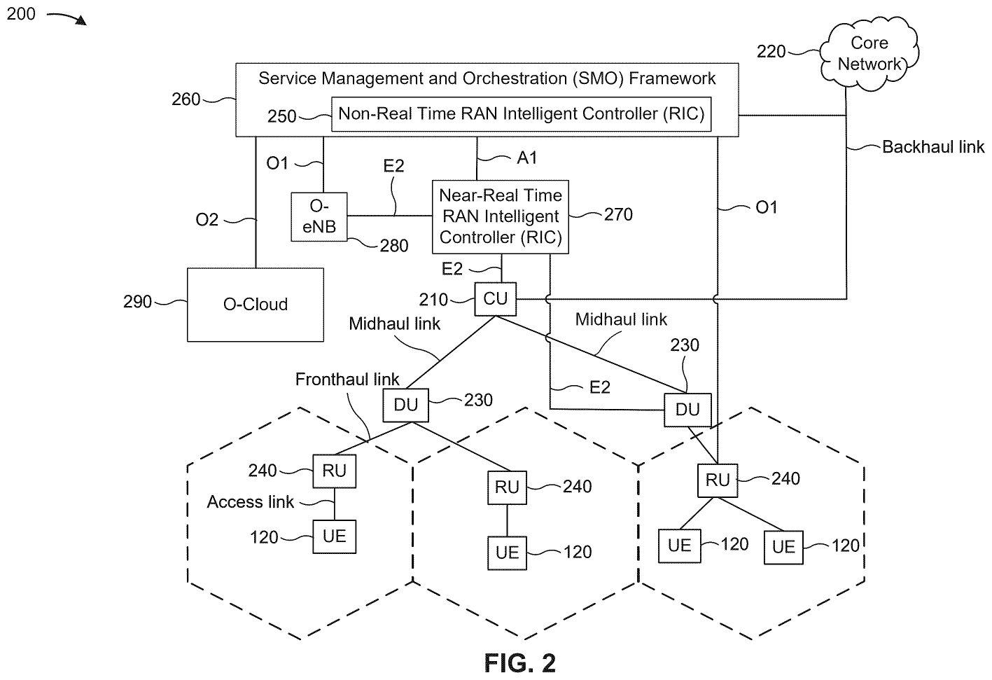

In some cases, a UE 120 may be equipped with multiple transceivers capable of operating various RF technologies. For example, in addition to the transceiver components described in connection with FIG. 2 (which, in some cases, may be used to communicate over a wireless communication network 100, as described), the UE 120 may be equipped with additional transceivers or similar components, such as transceivers associated with short-range wireless communication technologies, or the like. Short-range wireless communication enables wireless communication over relatively short distances (e.g., within 30 meters). Short range wireless communication enables wireless communication over relatively short distances (e.g., within 30 meters). For example, BLUETOOTH® is a wireless technology standard for exchanging data over short distances using short-wavelength ultra-high frequency (UHF) radio waves from 2.4 gigahertz (GHz) to 2.485 GHz. BLUETOOTH® Low Energy (BLE) is a form of BLUETOOTH® communication that allows for communication with devices running on low power. Such devices may include beacons, which are wireless communication devices that may use low-energy communication technology for locationing, proximity marketing, or other purposes. Furthermore, such devices may serve as nodes (e.g., relay nodes) of a wireless mesh network that communicates and/or relays information to a managing platform or hub associated with the wireless mesh network. Other short-range wireless communication technologies may exist, such as UWB technologies.

UWB connectivity is a short-range, wireless communication protocol that operates with a very high frequency as compared to other short-range wireless communication technologies (e.g., Bluetooth, WLAN, Zigbee, or the like) and uses a relatively wide frequency band (e.g., 500 MHz or greater) as compared to other short-range wireless communication technologies, which makes UWB useable for high-resolution positioning, localization, and high-speed data transfer, among other examples, with low power consumption and interference purposes. In some cases, UWB technology may be used for location discovery, device ranging, or asset tracking, among other examples.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a, a cell 130b, and a cell 130c), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IOT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a UE 120 in the third category (a RedCap UE) may support lower latency communication than a UE 120 in the first category (an NB-IOT UE or an eMTC UE), and a UE 120 in the second category (a mission-critical IoT UE or a premium UE) may support lower latency communication than the UE 120 in the third category. Additionally or alternatively, in some examples, a UE 120 in the third category (a RedCap UE) may support higher wireless communication throughput than a UE 120 in the first category (an NB-IOT UE or an eMTC UE), and a UE 120 in the second category (a mission-critical IoT UE or a premium UE) may support higher wireless communication throughput than the UE 120 in the third category. Additionally or alternatively, in some examples, a UE 120 in the first category (an NB-IOT UE or an eMTC UE) may support longer battery life than a UE 120 in the third category (a RedCap UE), and the UE 120 in the third category may support longer battery life than a UE 120 in the second category (a mission-critical IoT UE or a premium UE).

In some examples, a UE 120 of the third category (a RedCap UE) may have capabilities that satisfy first device or performance requirements but not second device or performance requirements (such as parameters specified for NR UEs 120 other than UEs 120 of the third category), while a UE 120 of the second category (a mission-critical IoT UE or a premium UE) may have capabilities that satisfy the second device or performance requirements (and also the first device or performance requirements, in some examples). For example, a UE 120 of the third category may support a lower maximum MCS (for example, a modulation scheme such as quadrature phase shift keying (QPSK)) than an MCS supported by a UE 120 of the second category (for example, a modulation scheme such as 256-quadrature amplitude modulation (QAM)).

As another example, a UE 120 of the third category may support a lower maximum transmit power than a maximum transmit power of a UE 120 of the second category. As another example, a UE 120 of the third category may have a less advanced beamforming capability than a beamforming capability of a UE 120 of the second category (for example, a RedCap UE may not be capable of forming as many beams as a premium UE). As another example, a UE 120 of the third category may require a longer processing time than a processing time of a UE 120 of the second category. As another example, a UE 120 of the third category may include less hardware or less complex hardware (such as fewer antennas, fewer transmit antennas, and/or fewer receive antennas) than a UE 120 of the second category. As another example, a UE 120 of the third category may not be capable of communicating on as wide of a maximum BWP as a UE 120 of the second category.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as the processing system 140 and/or the processing system 145. In some examples, each of the antenna elements of an antenna may include one or more sub-elements for radiating or receiving RF signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. In some examples, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi-co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communication devices, networks, or services.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110c (for example, a relay network node) may communicate with the network node 110a (for example, a macro network node) and the UE 120f in order to facilitate communication between the network node 110a and the UE 120f (for example, when the UE 120f is outside a coverage area of the cell 130a provided by the network node 110a). Additionally, or alternatively, a UE 120 may be or may operate as a relay that can relay transmissions to or from other UEs 120 or other wireless communication devices. A UE 120 that relays communications may be referred to as a UE relay or a relay UE, among other examples.

In some examples, two or more UEs 120 (for example, shown as UE 120a and UE 120g or the UE 120g and the UE 120h) may communicate directly with one another using sidelink communications (for example, without communicating by way of a network node 110 as an intermediary). As an example, the UE 120a may directly transmit data, control information, or other signaling as a sidelink communication to the UE 120g. This is in contrast to, for example, the UE 120a first transmitting data in an uplink communication to a network node 110e, which then transmits the data to the UE 120h in a downlink communication. In various examples, the UEs 120 may transmit and receive sidelink communications using peer-to-peer (P2P) communication protocols, D2D communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110e may schedule and/or allocate resources for sidelink communications between UEs 120 in the wireless communication network 100. For example, the cell 130c may include a V2X network supported by the network node 110c. In some examples, the network node 110e may be a roadside unit or other device deployed in the V2X network. In some other deployments and configurations, a UE 120 (instead of a network node 110) may perform, or collaborate or negotiate with one or more other UEs to perform, scheduling operations, resource selection operations, and/or other operations for sidelink communications. Sidelink data and control transmissions (that is, transmissions directly between two or more UEs 120) may generally use similar techniques as were described for uplink data and control transmission, and may use sidelink-specific channels such as a PSSCH, a PSCCH, and/or a PSFCH.

Some UEs 120, such as the UE 120i, may support one or more XR functionalities. For example, the UE 120i may be an XR device or may be associated with an XR device (for example, the UE 120i may be connected to the XR device, such as via a wired (for example, universal serial bus (USB), or serial advanced technology attachment (SATA)) connection and/or a wireless (for example, Bluetooth, Wi-Fi, 5G) connection). XR functionalities may include augmented reality (AR), virtual reality (VR), or mixed reality (MR), among other examples. For example, when providing an XR service, the UE 120i may provide rendered data via a display (such as a screen), a set of VR goggles, a heads-up display, or another type of display. The XR device may be an AR glasses device, a VR glass device, or other gaming device.

The XR functionalities may be supported by an application server. The application server may host an application, such as a gaming application, a video streaming application, an XR, VR, or AR application, and/or another type of application for which communication flows of streaming data are provided between a UE 120 and the application server, between an XR device and the application server, and/or between the application server and another device in the wireless communication network 100, such as network node 110f. The application server may be included in an edge server, a cloud environment, and/or another type of server environment. A UE 120 and/or an XR device may execute an application client associated with the application hosted by the application server, such as a gaming application client, a video streaming application client, an XR application client, a VR application client, an AR application client, and/or another type of application client.

In some aspects, the UE 120 may include a communication manager 150. As described in more detail elsewhere herein, the communication manager 150 may receive, from a network node via an access link, a first set of one or more signals including at least one instance of a data set; receive, from a transmitter wireless device via a sidelink, a second set of one or more signals including a plurality of repetitions of the data set and including a set of one or more respective sidelink reference signals corresponding to the plurality of repetitions of the data set; and perform a data processing procedure, according to the set of one or more respective sidelink reference signals, on the first set of one or more signals and the second set of one or more signals to generate the data set. Additionally, or alternatively, the communication manager 150 may perform one or more other operations described herein.

In some aspects, the transmitter wireless device may include a communication manager 150. As described in more detail elsewhere herein, the communication manager 150 may receive, from a network node via an access link, a first set of one or more signals including at least one instance of a data set intended for a receiver UE; generate a plurality of repetitions of the data set in association with scaling the data set according to one or more parameters associated with a sidelink between the receiver UE and the transmitter wireless device; and transmit, to the receiver UE via the sidelink, a second set of one or more signals including the plurality of repetitions of the data set and including a set of one or more respective sidelink reference signals corresponding to the plurality of repetitions of the data set. Additionally, or alternatively, the communication manager 150 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUS 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-cNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

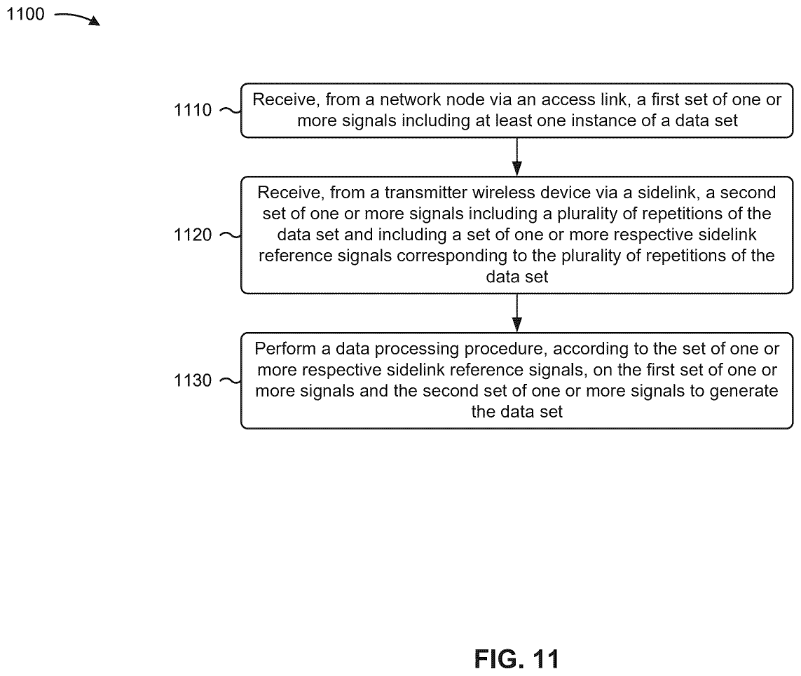

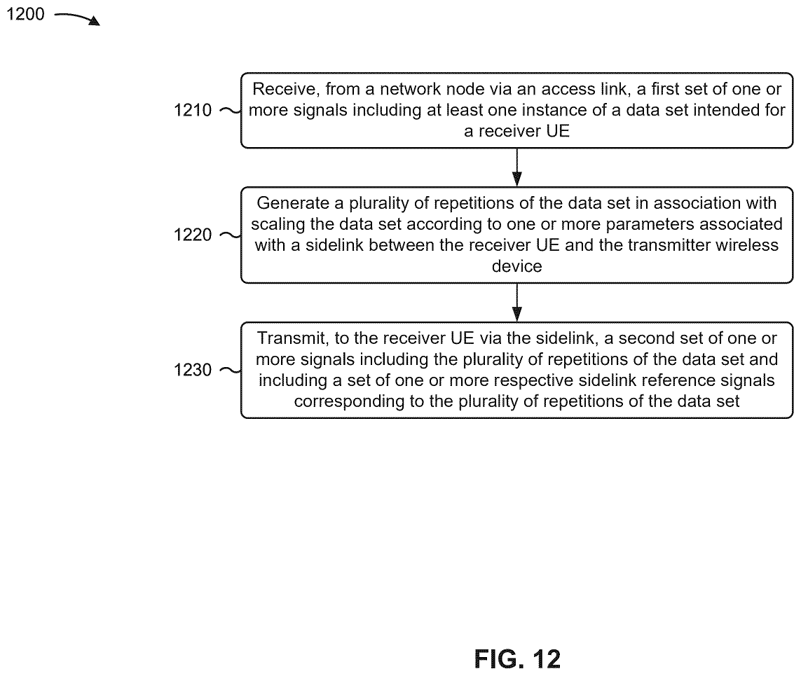

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with UE DL antenna augmentation associated with sidelink communications via UWB, FR2, and/or FR3, as described in more detail elsewhere herein. For example, the processing system 145 of the network node 110, the processing system 140 of the UE 120, the CU 210, the DU 230, or the RU 240 may perform or direct operations of, for example, process 1100 of FIG. 11, process 1200 of FIG. 12, or other processes as described herein (alone or in conjunction with one or more other processors). In some aspects, the transmitter wireless device described herein is a UE 120, is included in a UE 120, or includes one or more components of a UE 120 shown in FIG. 1. Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1100 of FIG. 11, process 1200 of FIG. 12, or other processes as described herein. In some examples, executing instructions may include running the instructions, converting the instructions, compiling the instructions, and/or interpreting the instructions, among other examples.

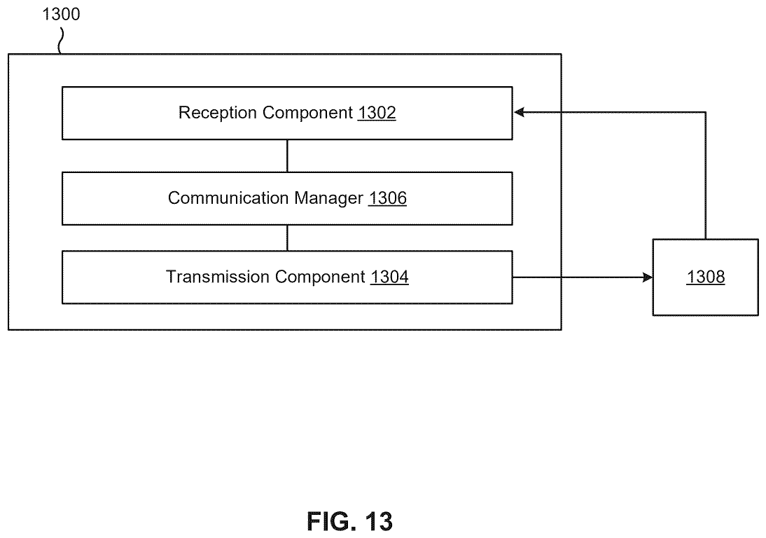

In some aspects, a receiver UE 120 includes means for receiving, from a network node via an access link, a first set of one or more signals including at least one instance of a data set; means for receiving, from a transmitter wireless device via a sidelink, a second set of one or more signals including a plurality of repetitions of the data set and including a set of one or more respective sidelink reference signals corresponding to the plurality of repetitions of the data set; and/or means for performing a data processing procedure, according to the set of one or more respective sidelink reference signals, on the first set of one or more signals and the second set of one or more signals to generate the data set. The means for the receiver UE 120 to perform operations described herein may include, for example, one or more of communication manager 150, processing system 140, a radio, one or more RF chains, one or more transceivers, one or more antennas, one or more modems, a reception component (for example, reception component 1302 depicted and described in connection with FIG. 13), and/or a transmission component (for example, transmission component 1304 depicted and described in connection with FIG. 13), among other examples.

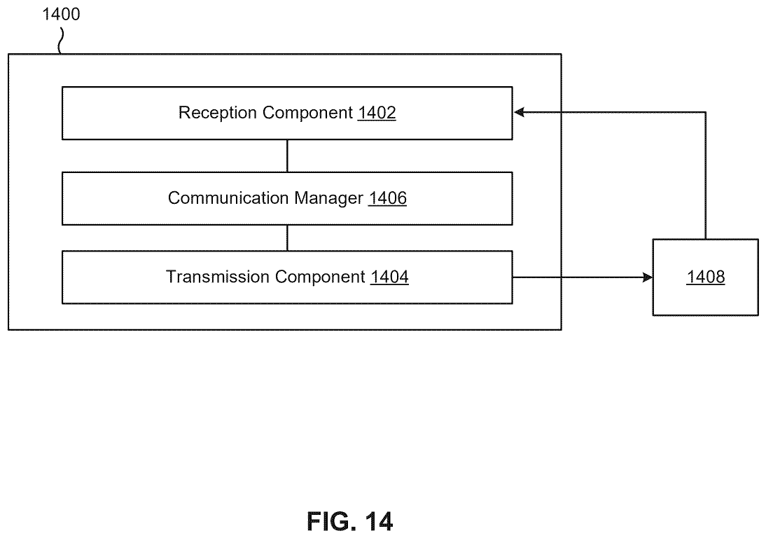

In some aspects, the transmitter wireless device includes means for receiving, from a network node via an access link, a first set of one or more signals including at least one instance of a data set intended for a receiver UE; means for generating a plurality of repetitions of the data set in association with scaling the data set according to one or more parameters associated with a sidelink between the receiver UE and the transmitter wireless device; and/or means for transmitting, to the receiver UE via the sidelink, a second set of one or more signals including the plurality of repetitions of the data set and including a set of one or more respective sidelink reference signals corresponding to the plurality of repetitions of the data set. In some aspects, the means for the transmitter wireless device to perform operations described herein may include, for example, one or more of communication manager 150, processing system 140, a radio, one or more RF chains, one or more transceivers, one or more antennas, one or more modems, a reception component (for example, reception component 1402 depicted and described in connection with FIG. 14), and/or a transmission component (for example, transmission component 1404 depicted and described in connection with FIG. 14), among other examples.

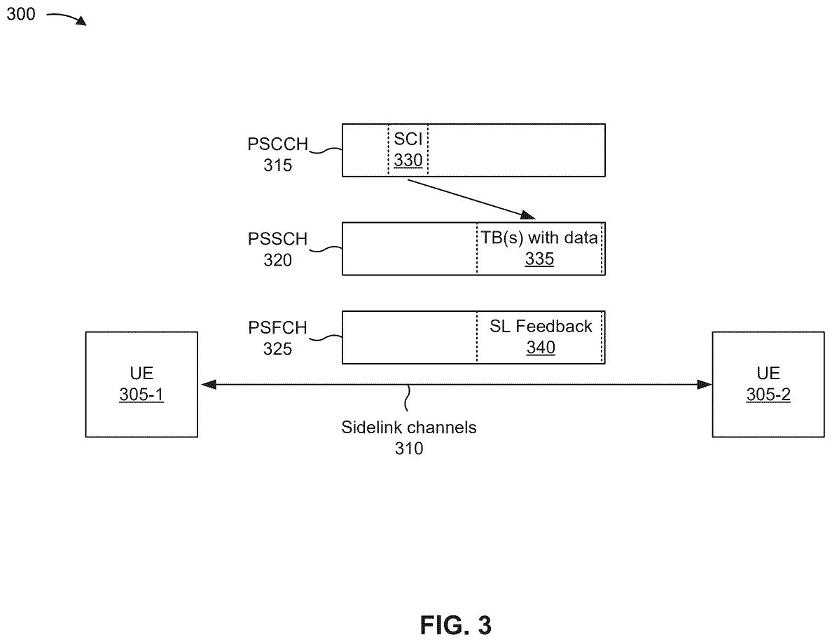

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a PSCCH 315, a PSSCH 320, and/or a PSFCH 325. The PSCCH 315 may be used to communicate control information, similar to a PDCCH and/or a PUCCH used for cellular communications with a network node 110 via an access link or an access channel. The PSSCH 320 may be used to communicate data, similar to a PDSCH and/or a PUSCH used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QOS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

In some examples, sidelink communications may be performed via UWB, FR2, and/or FR3 frequency bands. According to UWB regulations, a minimum bandwidth usage for a sidelink transmission is 500 MHz. UWB regulations may specify a power spectral density constraint of a sidelink transmission. In some examples, an overall allowed transmission power may increase linearly with the used bandwidth and still satisfy the power spectral density constraint. However, because the power spectral density constraint associated with UWB may be relatively low, even when the transmission power is distributed over the minimum bandwidth, a total transmit power may remain capped (e.g., capped at a relatively low level) due to the power spectral density constraint.

The minimum bandwidth usage may foster high transmit power, high throughput communications for some waveforms, which may increase throughput and/or data rates but may incur high energy costs at the UE 305-1 and/or the UE 305-2, consuming energy that may already be limited at sidelink devices and potentially at odds with the power spectral density constraint. Thus, sidelink communications (e.g., UWB sidelink communications) may suffer from high power consumption potential and complexity constraints (e.g., due to inherent characteristics of companion devices such as wearable UEs). Thus, it may be beneficial to decrease a total transmit power by implementing a waveform for communications that is associated with low complexity and may be relatively short in the time domain through sidelink frequency domain data set repetition to take advantage of increased channel capacity while satisfying minimum bandwidth and/or PSD constraints.

In some examples, sidelink communications may be performed via licensed bands (e.g., FR2 and/or FR3) and may have similar parameters and regulation to other sidelink communication schemes, such as CV2X. However, licensed sidelink communications may support many small networks (e.g., one per user), each comprising a small number of devices (2-4 devices, such as a UE, smart XR glasses, a smart watch, etc.). However, one small network may interfere with another nearby small network.

As indicated above, FIG. 3 is provided as an example. Other examples may differ from what is described with respect to FIG. 3.

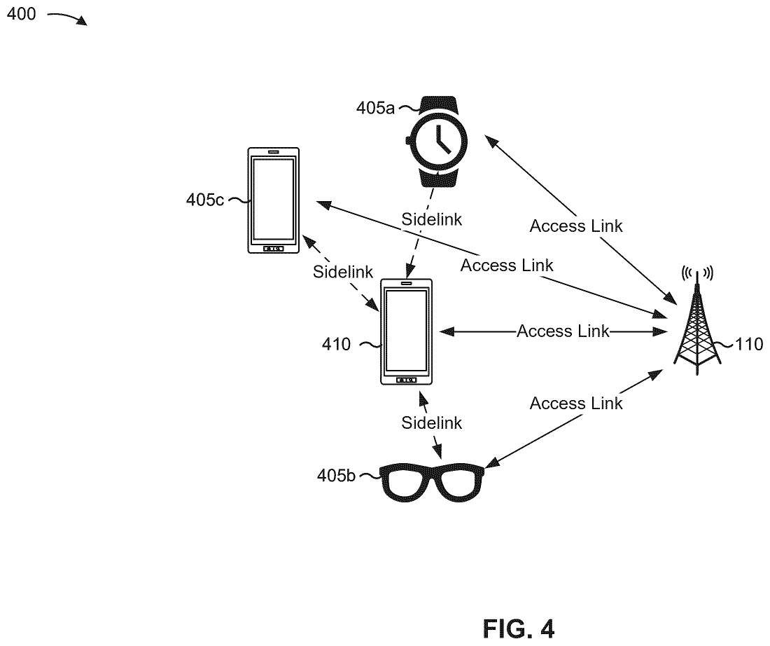

FIG. 4 is a diagram illustrating an example 400 of sidelink communications and access link communications, in accordance with the present disclosure. As wireless communication applications and use cases expand, it may come to pass that some users of a primary UE 410 may carry and/or use several wearable devices, such as companion devices 405 that communicate directly with a network node 110 in addition to the primary UE 410.

As shown in FIG. 4, primary UE 410, and companion devices 405, including smart watch 405a, smart glasses 405b, and/or auxiliary UE 405c may communicate with one another via a sidelink, as described above in connection with FIG. 3. The companion devices 405 and the primary UE 410, may in some examples, be part of a “small” licensed band network as also described in connection with FIG. 3. As further shown, in some sidelink modes, the network node 110 may communicate with the primary UE 410 (e.g., directly or via one or more network nodes), such as via a first access link. The primary UE 410 may correspond to one or more UEs described elsewhere herein, such as the UE 120 of FIG. 1. The companion devices 405 may correspond to one or more companion devices described elsewhere herein, and may be an example of a UE 120. For example, the UE 405c may include a UE (e.g., such as UE 120 described in connection with FIG. 1), such as a wearable UE, a companion UE, and/or an auxiliary UE that augments one of more functions of the primary UE 10a. A direct link between the primary UE 410 and/or a companion device 405 (e.g., via a PC5 interface) may be referred to as a sidelink, and a direct link between a network node 110 and the primary UE 410 and/or a companion device 405 (e.g., via a Uu interface) may be referred to as an access link. Sidelink communications may be transmitted via the sidelink, and access link communications may be transmitted via the access link. An access link communication may be either a downlink communication (from a network node 110 to the primary UE 410 and/or a companion device 405) and/or an uplink communication (from the primary UE 410 and/or a companion device 405 to a network node 110).

In some examples, companion devices may be used to augment communications performed via access link between the network node 110 and a primary UE 410, by communicating receiver antenna samples to the primary UE 410. For example, multiple devices (e.g., UEs 405, smart watch 405a, XR glasses 405b, among other examples), may receive data from the network node 110 and share local receive samples with each other via licensed (e.g., FR2 and/or FR3) and/or unlicensed (e.g., UWB) high-throughput sidelink. Antenna augmentation may improve throughput (via increased rank), may improve coverage, and may decrease the effects of interference by increasing robustness through repetition.

As indicated above, FIG. 4 is provided as an example. Other examples may differ from what is described with respect to FIG. 4.

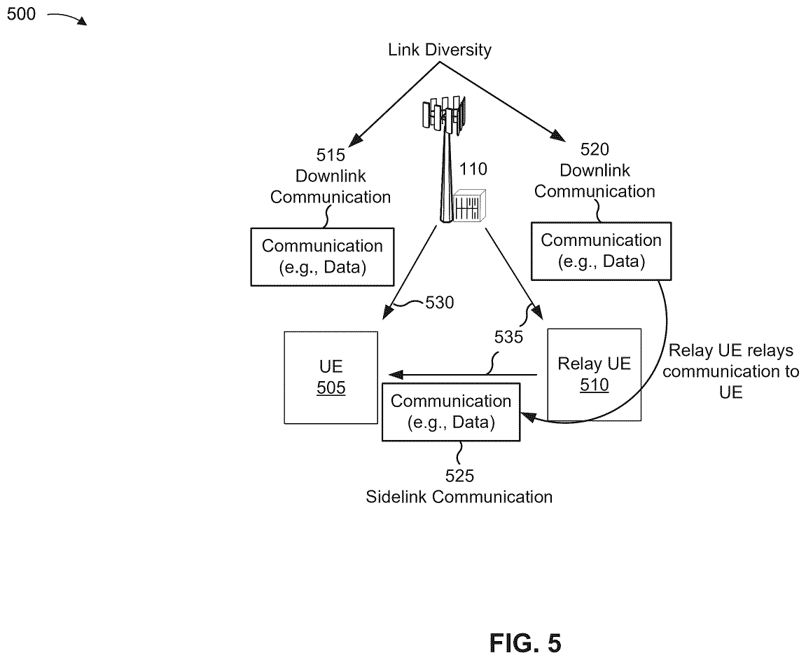

FIG. 5 is a diagram illustrating an example 500 of a relay UE that relays communications between a UE and a network node, in accordance with the present disclosure. As shown, example 500 includes a UE 505, a relay UE 510, and a network node 110. In example 500, the UE 505 is a primary UE, and the relay UE 510 is a companion device. In some aspects, the UE 505 is one UE 120, and the relay UE 510 is another UE 120. In some aspects, the UE 505 may be referred to as a remote UE.

As shown in FIG. 5, the UE 505 may receive a communication (e.g., data and/or control information) directly from the network node 110 as a downlink communication 515. Additionally, or alternatively, the UE 505 may receive a communication (e.g., data and/or control information) indirectly from the network node 110 via the relay UE 510. For example, the network node 110 may transmit the communication to the relay UE 510 as a downlink communication 520, and the relay UE 510 may relay (e.g., forward or transmit) the communication to the UE 505 as a sidelink communication 525.

In some aspects, the UE 505 may communicate directly with the network node 110 via a direct link 530. For example, the downlink communication 515 may be transmitted via the direct link 530. A communication transmitted via the direct link 530 between the UE 505 and the network node 110 (e.g., in the downlink communication 515) does not pass through and is not relayed by the relay UE 510. In some aspects, the UE 505 may communicate indirectly with the network node 110 via an indirect link 535. For example, the downlink communication 520 and the sidelink communication 525 may be transmitted via different segments of the indirect link 535. A communication transmitted via the indirect link 535 between the UE 505 and the network node 110 (e.g., in the downlink communication 520 and the sidelink communication 525) passes through and is relayed by the relay UE 510. Using the communication scheme shown in FIG. 5 may improve network performance and increase reliability by providing the UE 505 with link diversity for communicating with the network node 110.

In some examples, the UE 505 may receive a communication (e.g., the same communication) from the network node 110 via both the direct link 530 and the indirect link 535. In some examples, the indirect link may be an example of a licensed sidelink (e.g., FR2, and/or FR3) and/or an unlicensed sidelink (e.g., UWB sidelink). The UE 505 receiving the communication from the network node 110 via the direct link 530 and via the indirect link 535 may benefit from antenna augmentation. For example, the UE 505 may include a set of N antennas, and the UE 510 may include a set of M antennas, where N>M. The UE 505 receiving a communication (e.g., the same communication) from the network node 110 via both the direct link 530 and the indirect link 535 may experience a signal having an increased power, in comparison to receiving the communication from either the network node 110 or the UE 510, as if the UE 505 including more than N antennas.

As indicated above, FIG. 5 is provided as an example. Other examples may differ from what is described with respect to FIG. 5.

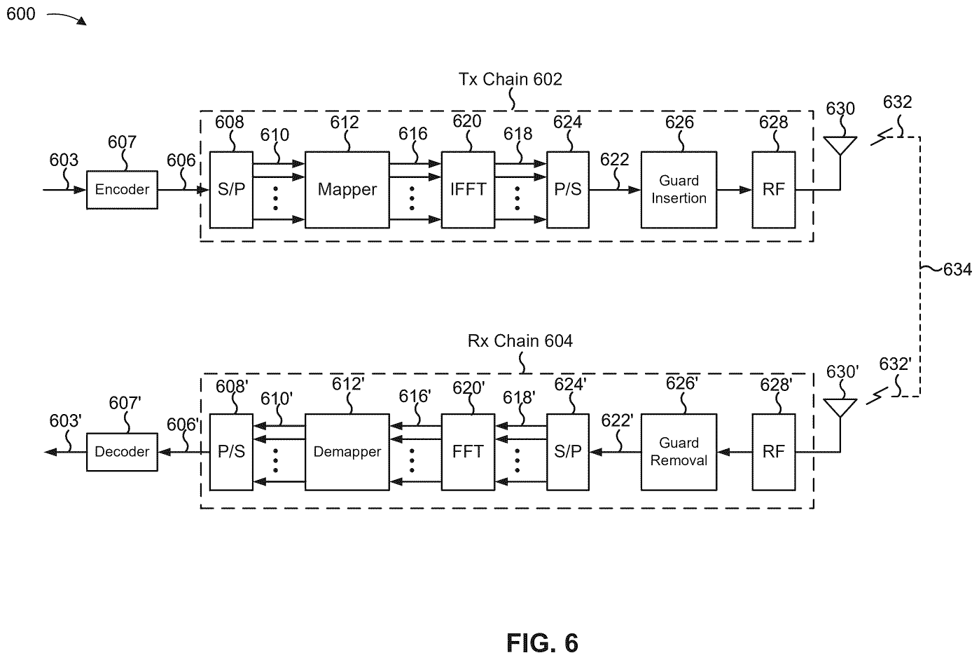

FIG. 6 is a diagram illustrating an example 600 of a transmit (Tx) chain 602 and a receive (Rx) chain 604 of a UE 120, in accordance with the present disclosure. In some aspects, one or more components of Tx chain 602 may be implemented in transmit processor 264, TX MIMO processor 266, modem 254, and/or controller/processor 280, as described above in connection with FIG. 2. In some aspects, Tx chain 602 may be implemented in UE 120 for transmitting data 606 (e.g., uplink data, an uplink reference signal, and/or uplink control information) to a network node 110 on an uplink channel.

An encoder 607 may alter a signal (e.g., a bitstream) 603 into data 606. Data 606 to be transmitted is provided from encoder 607 as input to a serial-to-parallel (S/P) converter 608. In some aspects, S/P converter 608 may split the transmission data into N parallel data streams 610.

The N parallel data streams 610 may then be provided as input to a mapper 612. Mapper 612 may map the N parallel data streams 610 onto N constellation points. The mapping may be done using a modulation constellation, such as binary phase-shift keying (BPSK), quadrature phase-shift keying (QPSK), 8 phase-shift keying (8PSK), quadrature amplitude modulation (QAM), etc. Thus, mapper 612 may output N parallel symbol streams 616, each symbol stream 616 corresponding to one of N orthogonal subcarriers of an inverse fast Fourier transform (IFFT) component 620. These N parallel symbol streams 616 are represented in the frequency domain and may be converted into N parallel time domain sample streams 618 by IFFT component 620.

In some aspects, N parallel modulations in the frequency domain correspond to N modulation symbols in the frequency domain, which are equal to N mapping and N-point IFFT in the frequency domain, which are equal to one (useful) OFDM symbol in the time domain, which are equal to N samples in the time domain. One OFDM symbol in the time domain, Ns, is equal to Ncp (the number of guard samples per OFDM symbol)+N (the number of useful samples per OFDM symbol).

The N parallel time domain sample streams 618 may be converted into an OFDM/OFDMA symbol stream 622 by a parallel-to-serial (P/S) converter 624. A guard insertion component 626 may insert a guard interval between successive OFDM/OFDMA symbols in the OFDM/OFDMA symbol stream 622. The output of guard insertion component 626 may then be upconverted to a desired transmit frequency band by a radio frequency (RF) front end 628. An antenna 630 may then transmit the resulting signal 632.

In some aspects, Rx chain 604 may utilize OFDM/OFDMA. In some aspects, one or more components of Rx chain 604 may be implemented in receive processor 258, MIMO detector 256, modem 254, and/or controller/processor 280, as described above in connection with FIG. 2. In some aspects, Rx chain 604 may be implemented in UE 120 for receiving data 606 (e.g., downlink data, a downlink reference signal, and/or downlink control information) from a network node 110 on a downlink channel.

A transmitted signal 632 is shown traveling over a wireless channel 634 from Tx chain 602 to Rx chain 604. When a signal 632′ is received by an antenna 630′, the received signal 632′ may be downconverted to a baseband signal by an RF front end 628′. A guard removal component 626′ may then remove the guard interval that was inserted between OFDM/OFDMA symbols by guard insertion component 626.

The output of guard removal component 626′ may be provided to an S/P converter 624′. The output may include an OFDM/OFDMA symbol stream 622′, and S/P converter 624′ may divide the OFDM/OFDMA symbol stream 622′ into N parallel time-domain symbol streams 618′, each of which corresponds to one of the N orthogonal subcarriers. A fast Fourier transform (FFT) component 620′ may convert the N parallel time-domain symbol streams 618′ into the frequency domain and output N parallel frequency-domain symbol streams 616′.

A demapper 612′ may perform the inverse of the symbol mapping operation that was performed by mapper 612, thereby outputting N parallel data streams 610′. A P/S converter 608′ may combine the N parallel data streams 610′ into a single data stream 606′. Ideally, data stream 606′ corresponds to data 606 that was provided as input to Tx chain 602. Data stream 606′ may be decoded into a decoded data stream 603′ by decoder 607′.

In some examples, aspects of the Tx chain 602 may be implemented by a companion device (e.g., such as companion device 405 described in connection with FIG. 4 and/or relay UE 510 described in connection with FIG. 5) for communicating with a primary UE 410 (e.g., such as primary UE 410 described in connection with FIG. 4 and/or UE 505 described in connection with FIG. 5) and/or by the primary UE to communicate with a network node. Additionally or alternatively, aspects of the Rx chain 604 may be implemented by a primary UE to receive receiver antenna samples from the companion device and/or by the companion device to communicate with the network node.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of components (e.g., one or more components) shown in FIG. 6 may perform one or more functions described as being performed by another set of components shown in FIG. 6.

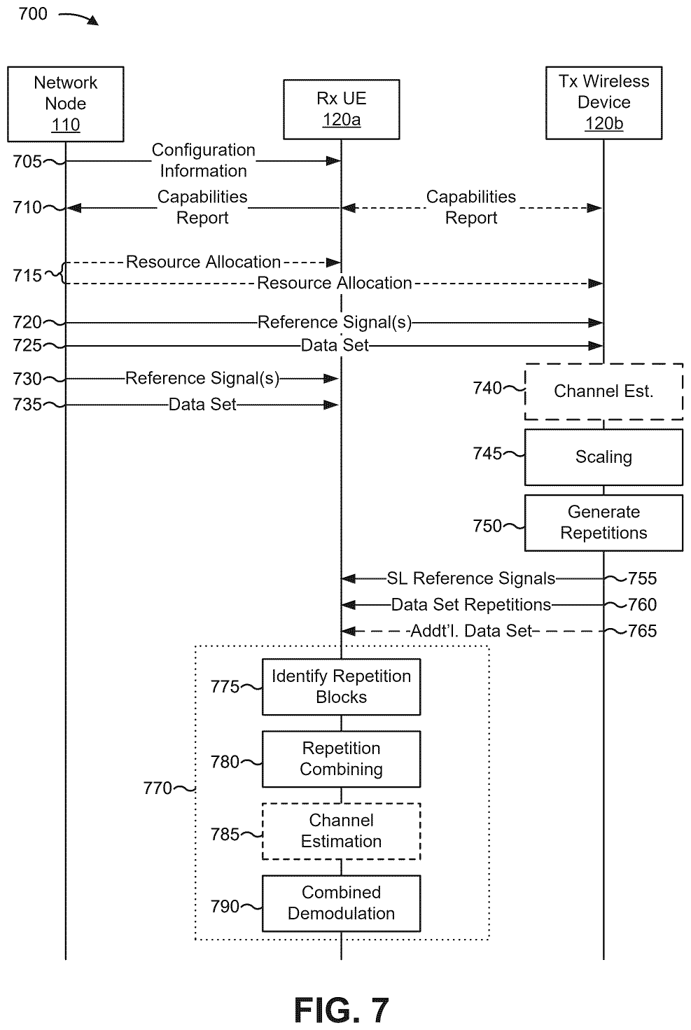

FIG. 7 is a diagram of an example 700 associated with downlink antenna augmentation using sidelink and companion devices, in accordance with the present disclosure. As shown in FIG. 7, a network node 110 (e.g., a network node 110 described in connection with FIGS. 1-2, a CU, a DU, and/or an RU) may communicate with a UE 120a (e.g., a UE 120 described in connection with FIGS. 1-2) and/or a Tx wireless device 120b (e.g., a UE 120 described in connection with FIGS. 1-2). In some aspects, the transmitter wireless device may include an auxiliary UE, a wearable UE, a reduced-complexity UE, and/or a companion device, as described herein. In some aspects, the network node 110, the Rx UE 120a, and the Tx wireless device 120b may be part of a wireless communication network (e.g., wireless communication network 100). The Rx UE 120a, the Tx wireless device 120b and the network node 110 may have established a wireless connection prior to operations shown in FIG. 7.

As shown by reference number 705, the network node 110 may transmit, and the Rx UE 120a may receive, configuration information. In some aspects, the Rx UE 120a may receive the configuration information via one or more of system information (e.g., a master information block (MIB) and/or a system information block (SIB), among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC CEs and/or one or more DCI messages, among other examples.

In some aspects, the configuration information may indicate that the Rx UE 120a is to perform combined modulation on a data set received from the network node 110 and Tx wireless device 120b. In some aspects, the configuration information may indicate a resource allocation over which the Rx UE 120a and/or the Tx wireless device 120b is to communicate via UWB, FR2, and/or FR3 frequency bands.

The Rx UE 120a may configure itself based at least in part on the configuration information. In some aspects, the Rx UE 120a may be configured to perform one or more operations described herein based at least in part on the configuration information.

As shown by reference number 710, the Rx UE 120a and/or the Tx wireless device 120b may transmit, and the network node 110, the Rx UE 120a, and/or the Tx wireless device 120b may receive, a capabilities report. The capabilities report may indicate whether the Rx UE 120a and/or the Tx wireless device 120b supports a feature and/or one or more parameters related to the feature. For example, the capability information may indicate a capability and/or parameter for generating data set repetitions, transmitting sidelink reference signals, performing data processing on a combined data set, among other examples. As another example, the capabilities report may indicate a capability and/or parameter for licensed (e.g., Fr2 and//or FR2) and/or unlicensed (e.g., UWB) sidelink communications. One or more operations described herein may be based on capability information of the capabilities report. For example, the Rx UE 120a and/or the Tx wireless device 120b may perform a communication in accordance with the capability information, or may receive configuration information that is in accordance with the capability information.

In some aspects, the configuration information described in connection with reference number 705 and/or the capabilities report(s) described in connection with reference number 710 may include information transmitted via multiple communications. Additionally, or alternatively, the network node 110 may transmit the configuration information, or a communication including at least a portion of the configuration information, before and/or after the Rx UE 120a and/or the Tx wireless device 120b transmits the capabilities report. For example, the network node 110 may transmit a first portion of the configuration information before the capabilities report, the Rx UE 120a and/or the Tx wireless device 120b may transmit at least a portion of the capabilities report, and the network node 110 may transmit a second portion of the configuration information after receiving the capabilities report.

As shown by reference number 715, the network node 110 may transmit, and the Rx UE 120a and/or the Tx wireless device 120b may receive, a resource allocation. For example, the network node 110 may transmit, and the Rx UE 120a and/or the Tx wireless device 120b may receive, a resource allocation for communications between wireless communication devices within a distance threshold. In some aspects, the distance threshold may include a size of a user specific network for communications over FR2 and/or FR3 sidelink. For example, a distance between the Rx UE 120a and the Tx wireless device 120b may be within the distance threshold. As a result, the Rx UE 120a and the Tx wireless device 120b may both correspond to a same user and/or may be allocated a same resource pool. In some aspects, the resource allocation may correspond to a user-specific network (e.g., a “small” network). In some aspects, the Rx UE 120a may receive the resource allocation from the network node 110 and may transmit an indication of the resource allocation to the Tx wireless device 120b.

In some aspects, a first resource pool that is associated with wireless communication devices within the distance threshold at least partially overlaps with a second resource pool that is associated with wireless communication devices within a second distance threshold that satisfies a resource reuse distance threshold. For example, sidelink over licensed bands (e.g., FR2 and/or FR3) may incorporate allocation of user-specific network resource pools to mitigate interference between relatively close users by allocating user-specific networks that are relatively close (e.g., within the resource reuse distance threshold) different resource pools. Additionally or alternatively, user-specific networks that are relatively separated (e.g., outside the resource reuse distance threshold) may be allocated resource pools that at least partially overlap.

As shown by reference number 720, the network node 110 may transmit, and the Tx wireless device 120b may receive, a set of one or more reference signals. For example, the network node 110 may transmit, and the Tx wireless device 120b may receive, a set of one or more reference signals communicated via an access link between the network node 110 and the Tx wireless device 120b. In some aspects, the one or more reference signals may include one or more DMRSs.

As shown by reference number 725, the network node 110 may transmit, and the Tx wireless device 120b may receive, a data set. For example, the Tx wireless device 120b may receive, from the network node 110 via the access link, a first set of one or more signals including at least one instance of a data set intended for the Rx UE 120a. In some aspects, the at least one instance of a data set and the set of one or more reference signals described in connection with reference number 720 may be communicated in a same transmission and/or message. In some aspects, the at least one instance of a data set and the set of one or more reference signals described in connection with reference number 720 may be communicated via different transmissions and/or messages. In some aspects, the set of one or more reference signals described in connection with reference number 720 may correspond to (e.g., may be associated with decoding) the at least one instance of the data set.

In some aspects, the Tx wireless device 120b may obtain the data set (e.g., frequency domain raw samples) from the first set of one or more signals using the set of one or more reference signals.

As shown by reference number 730, the network node 110 may transmit, and the Rx UE 120a may receive, a set of one or more reference signals. For example, the network node 110 may transmit, and the Rx UE 120a may receive, a set of one or more reference signals via an access link between the network node 110 and the Rx UE 120a. In some aspects, the one or more reference signals may include one or more DMRSs.

As shown by reference number 735, the network node 110 may transmit, and the Rx UE 120a may receive, the data set. For example, the Rx UE 120a may receive, from the network node 110 via the access link, a first set of one or more signals including at least one instance of the data set. In some aspects, the at least one instance of the data set and the set of one or more reference signals described in connection with reference number 730 may be communicated in a same transmission and/or message. In some aspects, the at least one instance of a data set and the set of one or more reference signals described in connection with reference number 730 may be communicated via different transmissions and/or messages. In some aspects, the set of one or more reference signals described in connection with reference number 730 may correspond to (e.g., may be associated with decoding) the at least one instance of the data set.

As shown by reference number 740, the Tx wireless device 120b may perform channel estimation. For example, the Tx wireless device 120b may measure a channel quality (or any other parameter) of the access link between the Tx wireless device 120b and/or the network node 110. In some aspects, the Tx wireless device may measure the channel using the one or more access link reference signals (e.g., DMRS) and/or a channel quality indication associated with the one or more access link reference signals (e.g., RSSI via DMRS).

As shown by reference number 745, the Tx wireless device 120b may perform scaling. For example, the Tx wireless device 120b may perform a scaling estimation procedure using the set of one or more respective sidelink reference signals. In some aspects, the scaling estimation procedure may include scaling the data set over a frequency range that satisfies a bandwidth threshold associated with the sidelink between the Rx UE 120a and the Tx wireless device 120b. In some aspects, the bandwidth threshold may include a minimum bandwidth associated with licensed (e.g., FR2 and/or FR3) and/or unlicensed (e.g., UWB) sidelink communications.

As shown by reference number 750, the Tx wireless device 120b may generate a set of repetitions of the data set. For example, the Tx wireless device 120b may generate a plurality of repetitions of the data set in association with scaling the data set (e.g., described in connection with reference number 745) according to one or more parameters associated with a sidelink between the Rx UE 120a and the Tx wireless device 120b. In some aspects, scaling the data set according to the one or more parameters may be associated with performing the scaling estimation procedure described in connection with reference number 745. For example, the UE 120 may perform scaling estimation based on RSSI, RSRP, and/or channel estimation and/or may apply the estimated scaling and/or may apply scaling to meet one or more UWB regulations. In some aspects, each repetition may be associated with a respective scrambling sequence (e.g., a user-specific scrambling sequence).

In some aspects, the one or more parameters associated with the sidelink between the Rx UE 120a and the Tx wireless device 120b include a frequency bandwidth threshold (e.g., a minimum bandwidth, as described herein), RSSI, a frequency range of the sidelink (e.g., FR2, FR3, and/or UWB), a PSD threshold, and/or a channel quality indication (e.g., a channel quality parameter derived from the one or more reference signals described in connection with reference number 720, among other examples).

As shown by reference number 755, the Tx wireless device 120b may transmit, and the Rx UE 120a may receive, a set of one or more sidelink reference signals. In some aspects, the set of one or more sidelink reference signals may include sidelink DMRS.

As shown by reference number 760, the Tx wireless device 120b may transmit, and the Rx UE 120a may receive, the set of repetitions of the data set. For example, the Tx wireless device 120b may transmit, to the Rx UE 120a via the sidelink, a second set of one or more signals including the plurality of repetitions of the data set. In some aspects, the plurality of repetitions of the data set and the set of one or more sidelink reference signals described in connection with reference number 755 may be communicated in a same transmission and/or message. In some aspects, the plurality of repetitions of the data set and the set of one or more sidelink reference signals described in connection with reference number 755 may be communicated via different transmissions and/or messages. In some aspects, the set of one or more sidelink reference signals described in connection with reference number 755 may correspond to (e.g., may be associated with decoding) the plurality of repetitions of the data set.

In some aspects, the second set of one or more signals includes a plurality of frequency domain samples, of the first set of one or more signals (e.g., described in connection with reference number 735), generated by the Tx wireless device 120b. In some aspects, the plurality of frequency domain samples may span a frequency bandwidth that satisfies a bandwidth threshold (e.g., a minimum bandwidth associated with licensed (e.g., FR2 and/or FR3) and/or unlicensed (e.g., UWB) sidelink communications).

As shown by reference number 765, in some examples, the Tx wireless device 120b may transmit, and the Rx UE 120a may receive, an additional set of repetitions including an additional data set. For example, the Tx wireless device 120b may transmit a plurality of repetitions of an additional data set multiplexed with the plurality of repetitions of the data set. In some aspects, the additional data set may originate from the network node 110 and/or a second network node 110.

As shown by reference number 770, the Rx UE 120a may perform a data processing procedure. For example, the Rx UE 120a may perform a data processing procedure, according to the set of one or more respective sidelink reference signals, on the first set of one or more signals and the second set of one or more signals to generate the data set.

For example, as shown by reference number 775, the data processing procedure may include the Rx UE 120a identifying repetition blocks of the set of repetitions of the data set. For example, the Rx UE 120a may identify a set of repetition blocks associated with the plurality of repetitions of the data set.

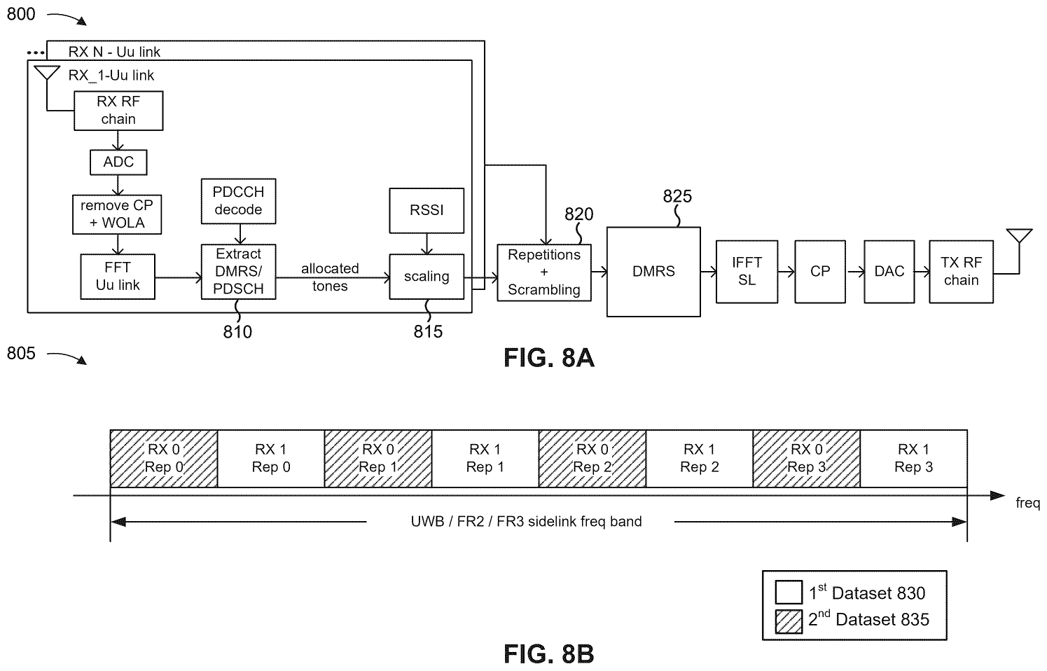

As shown by reference number 780, the data processing procedure may include the Rx UE 120a performing repetition combining. For example, the Rx UE 120a may perform ratio combining of the set of repetition blocks using the set of one or more respective sidelink reference signals to obtain a combined data set. In some aspects, the Rx UE 120a may combine the plurality of repetitions of the data set into a sidelink data set using the set of one or more respective sidelink reference signals For example, the Rx UE 120a may perform maximum ratio combining (MRC) as described with reference to FIG. 8.

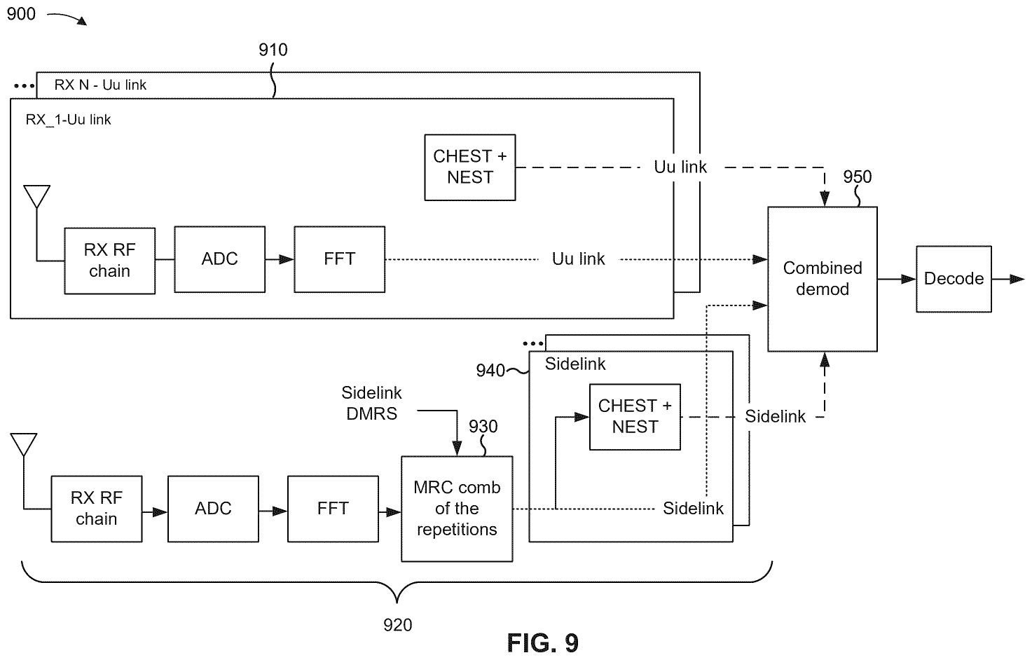

As shown by reference number 785, in some examples, the data processing procedure may include the Rx UE 120a performing channel estimation. For example, the Rx UE 120a may obtain a first channel estimation that is associated with the first set of one or more signals and a first estimated quantity of samples of the first set of one or more signals. In some aspects, the Rx UE 120a may obtain a second channel estimation that is associated with the second set of one or more signals and a second estimated quantity of samples of the second set of one or more signals. In some aspects, a second data processing procedure (e.g., a sub procedure) may include performing the channel estimation on the combined data set and performing a noise covariance estimation of the combined data set, for example, as described in connection with FIG. 9.

As shown by reference number 790, the data processing procedure may include the Rx UE 120a performing combined demodulation. For example, the Rx UE 120a may perform combined demodulation on the first set of one or more signals and the second set of one or more signals using a set of one or more respective access link reference signals. In some aspects, the combined demodulation may be associated with a first input including the first channel estimation and the first estimated quantity of samples (e.g., described in connection with reference number 785), and/or a second input including the second channel estimation and the second estimated quantity of samples (e.g., described in connection with reference number 785).

In some aspects, a quantity of received samples for performing the combined demodulation is associated with a quantity of received samples of the at least one instance of the data set and a quantity of received samples of the plurality of repetitions of the data set. For example, a dimension of the demodulator used for combined demodulation may be:

$$NRx = N\_Rx \_Uu \_PrimaryUE + N\_RX \_Uu \_Companion ,$$

where NRx is a total quantity of received samples, N_Rx_Uu_PrimaryUE is a total quantity of samples received by the Rx UE 120a from the network node 110, and N_RX_Uu_Companion is a total quantity of samples received by the Tx wireless device 120b from the network node 110.

As indicated above, FIG. 7 is provided as an example. Other examples may differ from what is described with respect to FIG. 7.

As described herein, a sidelink scheme for licensed (FR2 and/or FR3) and/or unlicensed UWB communications is described. On the companion device side, the sidelink scheme may include the extraction of a user allocation (e.g., user data) extracted from an FFT output (e.g., an FFT output described in connection with FIG. 6). The user allocation (e.g., including frequency domain raw IQ samples) may be repeated in the frequency domain to create a signal having a bandwidth that satisfies a minimum bandwidth guideline (e.g., regulation). A companion UE may prepare the user allocation for transmission without additional coding (e.g., coding that would otherwise be used to mitigate adverse channel conditions and/or noise), instead relying on the robustness provided by the transmission of multiple repetitions. Scrambling may be added to the repetitions to avoid large peak-to-average power ratios that might be caused by the repetitions. The companion UE may include single port sidelink DMRS per repetition to allow coherent combining of the repetitions at the primary UE. Additionally or alternatively, frequency selective scaling may be performed to meet UWB regulations (e.g., scaling per 1 MHz). For example, the same transmitted signal over sidelink may have a same spectral shape as the Uu channel spectral shape, which may violate PSD constraints without scaling.

On the companion device side, the sidelink scheme may include combining received repetition using the sidelink DMRSs. The primary UE may process the repetitions and the received user allocation for the network node using access link DMRSs from the network node. In some aspects, the DMRSs from the network node may pass through a double hop channel (e.g., from network node to companion device and/or from companion device to primary UE via sidelink). DMRS equalization may compensate for the sidelink hop such that the access link DMRSs represent the first hop. The user-specific scrambling and repetitions combining may serve as an interference mitigation mechanism between neighboring users. Thereby, the described techniques can be used to augment data reception at the primary UE by sharing local received samples between sidelink devices via licensed (e.g., FR2/FR3) and/or unlicensed (e.g., UWB) high throughput sidelink technologies.

FIG. 8A is a diagram illustrating an example 800 associated with sidelink reception/transmission processing, in accordance with the present disclosure. As shown in FIG. 8A, example 800 may include aspects of Rx chain 604 and/or Tx chain 602 described in connection with FIG. 6 and may include additional aspects such as PDSCH and/or DMRS extraction component 810, scaling component 815, and/or repetition and scrambling component 825, among other examples. In some aspects, the components described with reference to FIG. 8A may be performed by a companion device as described herein.

The companion device may include a set of Uu link Rx chains (e.g., N Rx chains) for access link communications. The companion device may receive a transmission, from a network node (e.g., such as network node 110 described in connection with FIG. 1) including a data set intended for a primary UE (e.g., such as primary UE 410 described in connection with FIG. 4 and/or UE 505 described in connection with FIG. 5).

The companion device may identify the transmitted resources. For example, the companion device may demodulate and decode the control data (e.g., PDCCH) of the transmission. The DMRS extraction component 810 may extract the data resources, access link reference signals, and/or tones of the transmission (e.g., PDSCH and/or DMRS) of the transmission.

The scaling component 815 may perform scaling. For example, the companion device may scale extracted data to meet any sidelink regulatory guidelines (e.g., such as a minimum frequency bandwidth use, interference considerations, and/or PSD constraints described with reference to FIGS. 3 and 4). For example, the companion device may apply scaling over a frequency range to satisfy sidelink guidelines and enhance the link performance. The scaling component 815 of the companion device may perform a channel measurement procedure. For example, the companion device may estimate sidelink channel conditions between the companion device and the primary UE and may estimate the scaling factor(s) based on the channel estimation. In some other examples, the companion device may measure a received signal strength (e.g., RSSI) of each received DMRS to directly measure the channel and determine the scaling factor(s). The companion device may perform the scaling of the data and/or one or more sidelink DMRS resources (e.g., REs) using the identified scaling factor(s). A DMRS may carry information used to estimate a radio channel for demodulation of an associated physical channel (e.g., PDCCH, PDSCH, PBCH, PUCCH, PUSCH, PSSCH, PSCCH). The design and mapping of a DMRS may be specific to a physical channel for which the DMRS is used for estimation. DMRSs are UE-specific, can be beamformed, can be confined in a scheduled resource, can be transmitted on a wideband, and can be transmitted only when necessary. DMRSs may be used for both downlink communications and uplink communications.

The component 820 may generate repetitions of the raw data (e.g., the extracted data) and/or scramble the repetitions of the raw data, as further illustrated with reference to FIG. 8B.

Component 825 may add sidelink DMRS to the sidelink transmission to support efficient combining (e.g., MRC combining) between the repetitions by the primary UE such that the primary UE may perform demodulation of the data repetitions using the original dimensions of the data.

In some aspects, components of the companion device may perform a number of additional operations, including an IFFT operation that is adjusted for sidelink communications, and/or CP addition, among other examples, to finish transmission side processing of the data repetitions. The companion device may transmit the repetition using a Tx RF chain.

FIG. 8B is a diagram illustrating an example 805 associated with a repetition scheme associated with sidelink reception/transmission processing, in accordance with the present disclosure. As shown in FIG. 8B, example 805 may include repetitions in the frequency domain of a first data set 830 frequency multiplexed with a second data set 835.

In some aspects, the component 820 of FIG. 8A may perform repetition over frequency. For example, the companion device may append one or more repetitions of the first data set 830 and/or the second data set 835. In some aspects, the one or more repetitions include repetitions of received tones. The companion device may apply a scrambling sequence to each of the frequence resources, which in some aspects may be different for each repetition and/or resource.

In some aspects, the companion device may receive the second data set from the network node and/or a second network node and may multiplex the first data set 830 and the second data set 835 from the one or more Uu link Rx chains.

As indicated above, FIGS. 8A and 8B are provided as examples. Other examples may differ from what is described with respect to FIGS. 8A and 8B.

FIG. 9 is a diagram illustrating an example 900 associated with sidelink reception processing, in accordance with the present disclosure. As shown in FIG. 9, example 900 includes at least one Uu link Rx chain 910 and a sidelink Rx chain 920. Example 900 may include aspects of Rx chain 604 described in connection with FIG. 6, and may include additional aspects, such as repetition combination component 930, sidelink CHEST/NEST component 940, and/or combined demodulation component 950, among other examples. In some aspects, the operations described with reference to FIG. 9 may be performed by components of a primary UE, as described herein.

In some aspects, the primary UE may receive at least one instance of the data set and one or more reference signals from a network node 110, and may perform one or more Uu Rx chain operations as described in connection with FIG. 6. By performing the one or more Uu Rx chain operations, the primary UE may obtain one or more of a Uu link data set, a channel estimation (CHEST), and/or a noise covariance estimation (NEST).

In some aspects, the primary UE may receive repetitions of the data set and one or more sidelink reference signals from a companion device, and may perform one or more sidelink Rx chain operations. For example, the primary UE may perform FFT, as described in connection with FIG. 6, using one or more parameters or numerologies for sidelink communications. The repetition combination component 930 may identify repetition blocks of the data repetition and may perform MRC combining of the repetition blocks using the sidelink reference signals described in connection with FIG. 8. The CHEST and NEST component 940 may perform channel estimation and noise covariance estimation of the combined signal using the one or more access link reference signals.

The combined demodulation component 950 may perform combined modulation using [Uu link data, Uu CHEST, Uu NEST] as a first input and using [combined sidelink data, sidelink CHEST, sidelink NEST] as a second input. In some aspects, a dimension of the demodulator used by the combined demodulation component 950 may be:

$$NRx = N\_Rx \_Uu \_PrimaryUE + N\_RX \_Uu \_Companion ,$$

where NRx is a total quantity of received samples, N_Rx_Uu_PrimaryUE is a total quantity of samples received by the primary UE from the network node, and N_RX_Uu_Companion is a total quantity of samples received by the companion device from the network node. The primary UE may identify the total quantity of samples received by the companion device from the network node based on the sidelink DMRS.

As indicated above, FIG. 9 is provided as an example. Other examples may differ from what is described with respect to FIG. 9.

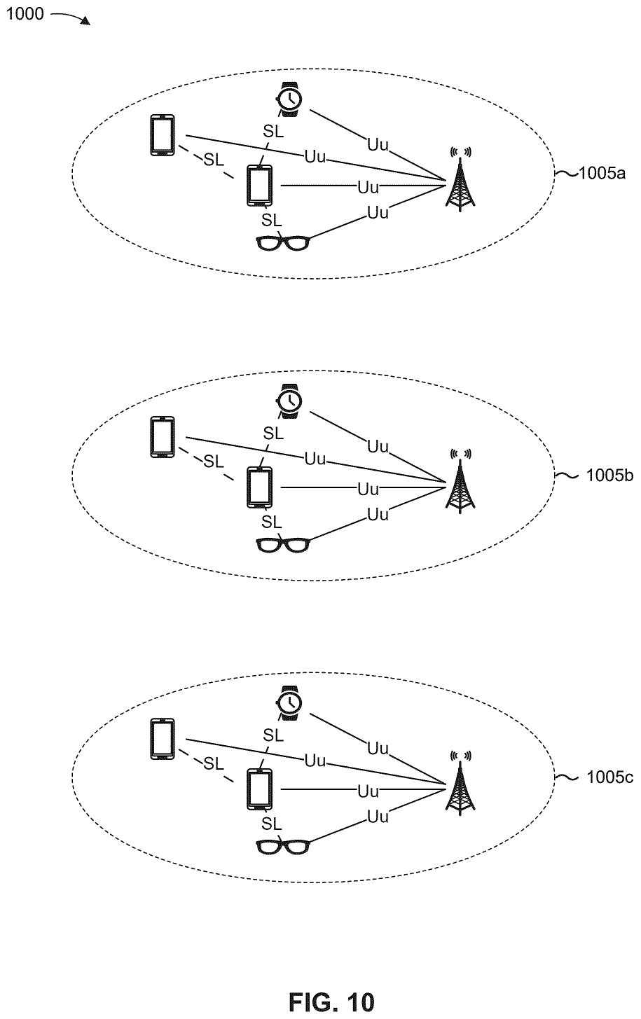

FIG. 10 is a diagram illustrating an example 1000 associated with FR2 and/or FR3 sidelink communications, in accordance with the present disclosure. As shown in FIG. 10, example 1000 includes a first network 1005a, a second network 1005b, and a third network 1005c, each of which may be an example of a small network as described in connection with FIG. 4 and/or may include aspects of wireless communication network 100 described in connection with FIG. 1. Each network 1000 may include one or more network nodes (e.g., one or more network nodes 110 described in connection with FIG. 1), one or more companion devices (e.g., one or more companion devices 405a described in connection with FIG. 4 and/or companion devices 510 described in connection with FIG. 5), and/or one or more primary UEs (e.g., one or more UEs 120 described in connection with FIG. 1, primary UE 410 described in connection with FIG. 4, and/or primary UE 505 described in connection with FIG. 5).

Sidelink over licensed bands (e.g., FR2 and/or FR3) may incorporate, in some examples, aspects of CV2X sidelink communications. However, sidelink over licensed bands may include many “small” networks (e.g., corresponding to each user), each comprising a small number of (e.g., ˜2-4) devices (e.g., UEs, companion devices). Each of these networks may be associated with a small coverage area (e.g., 1-2 meters). However, because these small networks may be operating in parallel close to other small networks, the small networks, such as networks 1005, may interfere with each other.

To mitigate the effects of interference, licensed sidelink communications may have a PSD constraint (e.g., similarly to the UWB sidelink described in connection with reference number FIG. 3). Limiting PSD may mitigate interference with little or no network coordination due to an increased path loss at these frequencies, limited transmission power (e.g., because FR2 and/or FR3 frequency bands are relatively narrower than UWB), and/or user-specific scrambling associated with repetition generation and/or combination (e.g., similar to a spread spectrum signal)

As a result, sidelink over licensed bands (e.g., FR2 and/or FR3) may incorporate aspects of UWB sidelink, including data set repetition and sidelink reference signals (e.g., described in connection with FIGS. 8 and 9) to generate a waveform with relatively low complexity and transmit power to satisfy PSD constraints while taking advantage of the increased channel throughout and/or data rates associated with sidelink over licensed bands. Additionally or alternatively, sidelink over licensed bands (e.g., FR2 and/or FR3) may incorporate allocation of resource pools (e.g., similarly to CV2X sidelink communications) to mitigate interference between relatively close users (e.g., in examples where the interference may not be sufficiently mitigated through PSD constraints and/or data set repetition described in connection with FIGS. 8 and 9).

For example, networks 1005a, 1005b, and 1005c may be in close proximity to each other (“close” in this context may refer to a distance at which one network 1005 may interfere with another network 1005 using licensed frequency band communications). To avoid interference, each network 1005 may be allocated a different resource pool. However, because networks 1005a and 1005c are relatively further apart (e.g., further apart than networks 1005a and 1005b, and/or 1005b and 1005c), networks 1005a and 1005c may use a same resource pool with relatively low risk of interference impact.

As indicated above, FIG. 10 is provided as an example. Other examples may differ from what is described with respect to FIG. 10.

FIG. 11 is a diagram illustrating an example process 1100 performed, for example, at a UE or an apparatus of a UE, in accordance with the present disclosure. Example process 1100 is an example where the apparatus or the UE (e.g., UE 120) performs operations associated with downlink antenna augmentation using sidelink and companion devices.

As shown in FIG. 11, in some aspects, process 1100 may include receiving, from a network node via an access link, a first set of one or more signals including at least one instance of a data set (block 1110). For example, the UE (e.g., using reception component 1302 and/or communication manager 1306, depicted in FIG. 13) may receive, from a network node via an access link, a first set of one or more signals including at least one instance of a data set, as described above.

As further shown in FIG. 11, in some aspects, process 1100 may include receiving, from a transmitter wireless device via a sidelink, a second set of one or more signals including a plurality of repetitions of the data set and including a set of one or more respective sidelink reference signals corresponding to the plurality of repetitions of the data set (block 1120). For example, the UE (e.g., using reception component 1302 and/or communication manager 1306, depicted in FIG. 13) may receive, from a transmitter wireless device via a sidelink, a second set of one or more signals including a plurality of repetitions of the data set and including a set of one or more respective sidelink reference signals corresponding to the plurality of repetitions of the data set, as described above.

As further shown in FIG. 11, in some aspects, process 1100 may include performing a data processing procedure, according to the set of one or more respective sidelink reference signals, on the first set of one or more signals and the second set of one or more signals to generate the data set (block 1130). For example, the UE (e.g., using communication manager 1306, depicted in FIG. 13) may perform a data processing procedure, according to the set of one or more respective sidelink reference signals, on the first set of one or more signals and the second set of one or more signals to generate the data set, as described above.

Process 1100 may include additional aspects, such as any single aspect or any combination of aspects described below and/or in connection with one or more other processes described elsewhere herein.

In a first aspect, performing the data processing procedure includes performing combined demodulation on the first set of one or more signals and the second set of one or more signals using a set of one or more respective access link reference signals.

In a second aspect, alone or in combination with the first aspect, process 1100 includes obtaining a first channel estimation that is associated with the first set of one or more signals and a first estimated quantity of samples of the first set of one or more signals, and obtaining a second channel estimation that is associated with the second set of one or more signals and a second estimated quantity of samples of the second set of one or more signals, wherein the combined demodulation is associated with at least one of a first input including the first channel estimation and the first estimated quantity of samples, or a second input including the second channel estimation and the second estimated quantity of samples.

In a third aspect, alone or in combination with one or more of the first and second aspects, a quantity of received samples for performing the combined demodulation is associated with a quantity of received samples of the at least one instance of the data set and a quantity of received samples of the plurality of repetitions of the data set.

In a fourth aspect, alone or in combination with one or more of the first through third aspects, performing the data processing procedure includes identifying a set of repetition blocks associated with the plurality of repetitions of the data set, and performing ratio combining of the set of repetition blocks using the set of one or more respective sidelink reference signals to obtain a combined data set.

In a fifth aspect, alone or in combination with one or more of the first through fourth aspects, the second set of one or more signals includes a plurality of frequency domain samples, of the first set of one or more signals, that are generated by the transmitter wireless device.

In a sixth aspect, alone or in combination with one or more of the first through fifth aspects, the plurality of frequency domain samples spans a frequency bandwidth that satisfies a bandwidth threshold.

In a seventh aspect, alone or in combination with one or more of the first through sixth aspects, process 1100 includes receiving a plurality of repetitions of an additional data set multiplexed with the plurality of repetitions of the data set.

In an eighth aspect, alone or in combination with one or more of the first through seventh aspects, a distance between the receiver UE and the transmitter wireless device is within a distance threshold.

In a ninth aspect, alone or in combination with one or more of the first through eighth aspects, process 1100 includes receiving a resource allocation for communications between wireless communication devices within the distance threshold.

In a tenth aspect, alone or in combination with one or more of the first through ninth aspects, a first resource pool that is associated with wireless communication devices within the distance threshold at least partially overlaps with a second resource pool that is associated with wireless communication devices within a second distance threshold that satisfies a resource reuse distance threshold.

In an eleventh aspect, alone or in combination with one or more of the first through tenth aspects, the transmitter wireless device comprises at least one of an auxiliary UE, a wearable UE, a reduced-complexity UE, or a companion device.

In a twelfth aspect, alone or in combination with one or more of the first through eleventh aspects, process 1100 includes receiving a set of one or more access link reference signals corresponding to the at least one instance of the data set.

In a thirteenth aspect, alone or in combination with one or more of the first through twelfth aspects, performing the data processing procedure includes combining the plurality of repetitions of the data set into a sidelink data set using the set of one or more respective sidelink reference signals, and performing a second data processing procedure, according to the set of one or more access link reference signals.

In a fourteenth aspect, alone or in combination with one or more of the first through thirteenth aspects, the set of one or more respective sidelink reference signals includes sidelink demodulation reference signals.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a transmitter wireless device or an apparatus of a transmitter wireless device, in accordance with the present disclosure. Example process 1200 is an example where the apparatus or the transmitter wireless device (e.g., transmitter wireless device 120b, depicted in FIG. 7 and/or apparatus 1400 depicted in FIG. 14) performs operations associated with downlink antenna augmentation using sidelink and companion devices.

As shown in FIG. 12, in some aspects, process 1200 may include receiving, from a network node via an access link, a first set of one or more signals including at least one instance of a data set intended for a receiver UE (block 1210). For example, the transmitter wireless device (e.g., using reception component 1402 and/or communication manager 1406, depicted in FIG. 14) may receive, from a network node via an access link, a first set of one or more signals including at least one instance of a data set intended for a receiver UE, as described above.

As further shown in FIG. 12, in some aspects, process 1200 may include generating a plurality of repetitions of the data set in association with scaling the data set according to one or more parameters associated with a sidelink between the receiver UE and the transmitter wireless device (block 1220). For example, the transmitter wireless device (e.g., using communication manager 1406, depicted in FIG. 140 may generate a plurality of repetitions of the data set in association with scaling the data set according to one or more parameters associated with a sidelink between the receiver UE and the transmitter wireless device, as described above.

As further shown in FIG. 12, in some aspects, process 1200 may include transmitting, to the receiver UE via the sidelink, a second set of one or more signals including the plurality of repetitions of the data set and including a set of one or more respective sidelink reference signals corresponding to the plurality of repetitions of the data set (block 1230). For example, the transmitter wireless device (e.g., using transmission component 1404 and/or communication manager 1406, depicted in FIG. 14) may transmit, to the receiver UE via the sidelink, a second set of one or more signals including the plurality of repetitions of the data set and including a set of one or more respective sidelink reference signals corresponding to the plurality of repetitions of the data set, as described above.

Process 1200 may include additional aspects, such as any single aspect or any combination of aspects described below and/or in connection with one or more other processes described elsewhere herein.

In a first aspect, process 1200 includes scaling the data set over a frequency range that satisfies a bandwidth threshold associated with the sidelink between the receiver UE and the transmitter wireless device.

In a second aspect, alone or in combination with the first aspect, each repetition is associated with a respective scrambling sequence.

In a third aspect, alone or in combination with one or more of the first and second aspects, process 1200 includes performing a scaling estimation procedure using the set of one or more respective sidelink reference signals, wherein scaling the data set according to the one or more parameters is associated with performing the scaling estimation procedure.

In a fourth aspect, alone or in combination with one or more of the first through third aspects, process 1200 includes receiving a set of one or more reference signals, and obtaining the data set from the first set of one or more signals using the set of one or more reference signals.

In a fifth aspect, alone or in combination with one or more of the first through fourth aspects, the second set of one or more signals includes a plurality of frequency domain samples, of the first set of one or more signals, that are generated by the transmitter wireless device.

In a sixth aspect, alone or in combination with one or more of the first through fifth aspects, the plurality of frequency domain samples spans a frequency bandwidth that satisfies a bandwidth threshold.

In a seventh aspect, alone or in combination with one or more of the first through sixth aspects, process 1200 includes transmitting a plurality of repetitions of an additional data set multiplexed with the plurality of repetitions of the data set.

In an eighth aspect, alone or in combination with one or more of the first through seventh aspects, a distance between the receiver UE and the transmitter wireless device is within a distance threshold.

In a ninth aspect, alone or in combination with one or more of the first through eighth aspects, process 1200 includes receiving a resource allocation for communications between wireless communication devices within the distance threshold.

In a tenth aspect, alone or in combination with one or more of the first through ninth aspects, a first resource pool that is associated with wireless communication devices within the distance threshold at least partially overlaps with a second resource pool that is associated with wireless communication devices within a second distance threshold that satisfies a resource reuse distance threshold.

In an eleventh aspect, alone or in combination with one or more of the first through tenth aspects, the transmitter wireless device comprises at least one of an auxiliary UE, a wearable UE, a reduced-complexity UE, or a companion device.

In a twelfth aspect, alone or in combination with one or more of the first through eleventh aspects, the set of one or more respective sidelink reference signals include sidelink demodulation reference signals.

In a thirteenth aspect, alone or in combination with one or more of the first through twelfth aspects, the one or more parameters associated with the sidelink between the receiver UE and the transmitter wireless device includes one or more of a frequency bandwidth threshold, a reference signal strength indication, a frequency range of the sidelink, a power spectral density threshold, or a channel quality indication.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a receiver UE, or a receiver UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 140 described in connection with FIG. 1) of the receiver UE.

In some aspects, the apparatus 1300 may be configured to perform one or more operations described herein in connection with FIGS. 7-10. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the receiver UE described in connection with FIG. 1.

Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the receiver UE described above in connection with FIG. 1, such as a radio, one or more RF chains, one or more transceivers, or one or more modems, each of which may in turn be coupled with one or more antennas of the receiver UE.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the receiver UE described above in connection with FIG. 1, such as a radio, one or more RF chains, one or more transceivers, or one or more modems, each of which may in turn be coupled with one or more antennas of the receiver UE described in connection with FIG. 1. In some aspects, the transmission component 1304 may be co-located with the reception component 1302.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive, from a network node via an access link, a first set of one or more signals including at least one instance of a data set. The reception component 1302 may receive, from a transmitter wireless device via a sidelink, a second set of one or more signals including a plurality of repetitions of the data set and including a set of one or more respective sidelink reference signals corresponding to the plurality of repetitions of the data set. The communication manager 1306 may perform a data processing procedure, according to the set of one or more respective sidelink reference signals, on the first set of one or more signals and the second set of one or more signals to generate the data set.

The communication manager 1306 may perform combined demodulation on the first set of one or more signals and the second set of one or more signals using a set of one or more respective access link reference signals.

The reception component 1302 may obtain a first channel estimation that is associated with the first set of one or more signals and a first estimated quantity of samples of the first set of one or more signals.

The reception component 1302 may obtain a second channel estimation that is associated with the second set of one or more signals and a second estimated quantity of samples of the second set of one or more signals, wherein the combined demodulation is associated with at least one of a first input including the first channel estimation and the first estimated quantity of samples, or a second input including the second channel estimation and the second estimated quantity of samples.

The communication manager 1306 may identify a set of repetition blocks associated with the plurality of repetitions of the data set. The communication manager 1306 may perform ratio combining of the set of repetition blocks using the set of one or more respective sidelink reference signals to obtain a combined data set.

The reception component 1302 may receive a plurality of repetitions of an additional data set multiplexed with the plurality of repetitions of the data set.

The reception component 1302 may receive a resource allocation for communications between wireless communication devices within the distance threshold.

The reception component 1302 may receive a set of one or more access link reference signals corresponding to the at least one instance of the data set.

The communication manager 1306 may combine the plurality of repetitions of the data set into a sidelink data set using the set of one or more respective sidelink reference signals. The communication manager 1306 may perform a second data processing procedure, according to the set of one or more access link reference signals.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a transmitter wireless device, or a transmitter wireless device may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 140 described in connection with FIG. 1) of the transmitter wireless device.

In some aspects, the apparatus 1400 may be configured to perform one or more operations described herein in connection with FIGS. 7-10. Additionally, or alternatively, the apparatus 1400 may be configured to perform one or more processes described herein, such as process 1200 of FIG. 12, or a combination thereof. In some aspects, the apparatus 1400 and/or one or more components shown in FIG. 14 may include one or more components of the transmitter wireless device described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the transmitter wireless device described above in connection with FIG. 1, such as a radio, one or more RF chains, one or more transceivers, or one or more modems, each of which may in turn be coupled with one or more antennas of the transmitter wireless device.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the transmitter wireless device described above in connection with FIG. 1, such as a radio, one or more RF chains, one or more transceivers, or one or more modems, each of which may in turn be coupled with one or more antennas of the transmitter wireless device described in connection with FIG. 1. In some aspects, the transmission component 1404 may be co-located with the reception component 1402.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may receive, from a network node via an access link, a first set of one or more signals including at least one instance of a data set intended for a receiver UE. The communication manager 1406 may generate a plurality of repetitions of the data set in association with scaling the data set according to one or more parameters associated with a sidelink between the receiver UE and the transmitter wireless device. The transmission component 1404 may transmit, to the receiver UE via the sidelink, a second set of one or more signals including the plurality of repetitions of the data set and including a set of one or more respective sidelink reference signals corresponding to the plurality of repetitions of the data set.

The communication manager 1406 may scale the data set over a frequency range that satisfies a bandwidth threshold associated with the sidelink between the receiver UE and the transmitter wireless device. The communication manager 1406 may perform a scaling estimation procedure using the set of one or more respective sidelink reference signals, wherein scaling the data set according to the one or more parameters is associated with performing the scaling estimation procedure. The reception component 1402 may receive a set of one or more reference signals.

The communication manager 1406 may obtain the data set from the first set of one or more signals using the set of one or more reference signals.

The transmission component 1404 may transmit a plurality of repetitions of an additional data set multiplexed with the plurality of repetitions of the data set.

The reception component 1402 may receive a resource allocation for communications between wireless communication devices within the distance threshold.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a receiver user equipment (UE), comprising: receiving, from a network node via an access link, a first set of one or more signals including at least one instance of a data set; receiving, from a transmitter wireless device via a sidelink, a second set of one or more signals including a plurality of repetitions of the data set and including a set of one or more respective sidelink reference signals corresponding to the plurality of repetitions of the data set; and performing a data processing procedure, according to the set of one or more respective sidelink reference signals, on the first set of one or more signals and the second set of one or more signals to generate the data set.

Aspect 2: The method of Aspect 1, wherein performing the data processing procedure comprises: performing combined demodulation on the first set of one or more signals and the second set of one or more signals using a set of one or more respective access link reference signals.

Aspect 3: The method of Aspect 2, further comprising: obtaining a first channel estimation that is associated with the first set of one or more signals and a first estimated quantity of samples of the first set of one or more signals; and obtaining a second channel estimation that is associated with the second set of one or more signals and a second estimated quantity of samples of the second set of one or more signals, wherein the combined demodulation is associated with at least one of a first input including the first channel estimation and the first estimated quantity of samples, or a second input including the second channel estimation and the second estimated quantity of samples.

Aspect 4: The method of any of Aspects 2-3, wherein a quantity of received samples for performing the combined demodulation is associated with a quantity of received samples of the at least one instance of the data set and a quantity of received samples of the plurality of repetitions of the data set.

Aspect 5: The method of any of Aspects 1-4, wherein performing the data processing procedure comprises: identifying a set of repetition blocks associated with the plurality of repetitions of the data set; and performing ratio combining of the set of repetition blocks using the set of one or more respective sidelink reference signals to obtain a combined data set.

Aspect 6: The method of any of Aspects 1-5, wherein the second set of one or more signals includes a plurality of frequency domain samples, of the first set of one or more signals, that are generated by the transmitter wireless device.

Aspect 7: The method of Aspect 6, wherein the plurality of frequency domain samples spans a frequency bandwidth that satisfies a bandwidth threshold.

Aspect 8: The method of any of Aspects 1-7, further comprising: receiving a plurality of repetitions of an additional data set multiplexed with the plurality of repetitions of the data set.

Aspect 9: The method of any of Aspects 1-8, wherein a distance between the receiver UE and the transmitter wireless device is within a distance threshold.

Aspect 10: The method of Aspect 9, further comprising: receiving a resource allocation for communications between wireless communication devices within the distance threshold.

Aspect 11: The method of any of Aspects 9-10, wherein a first resource pool that is associated with wireless communication devices within the distance threshold at least partially overlaps with a second resource pool that is associated with wireless communication devices within a second distance threshold that satisfies a resource reuse distance threshold.

Aspect 12: The method of any of Aspects 1-11, wherein the transmitter wireless device comprises at least one of an auxiliary UE, a wearable UE, a reduced-complexity UE, or a companion device.

Aspect 13: The method of any of Aspects 1-12, further comprising: receiving a set of one or more access link reference signals corresponding to the at least one instance of the data set.

Aspect 14: The method of Aspect 13, wherein performing the data processing procedure comprises: combining the plurality of repetitions of the data set into a sidelink data set using the set of one or more respective sidelink reference signals; and performing a second data processing procedure, according to the set of one or more access link reference signals.

Aspect 15: The method of any of Aspects 1-14, wherein the set of one or more respective sidelink reference signals include sidelink demodulation reference signals.

Aspect 16: A method of wireless communication performed by a transmitter wireless device, comprising: receiving, from a network node via an access link, a first set of one or more signals including at least one instance of a data set intended for a receiver UE; generating a plurality of repetitions of the data set in association with scaling the data set according to one or more parameters associated with a sidelink between the receiver UE and the transmitter wireless device; and transmitting, to the receiver UE via the sidelink, a second set of one or more signals including the plurality of repetitions of the data set and including a set of one or more respective sidelink reference signals corresponding to the plurality of repetitions of the data set.

Aspect 17: The method of Aspect 16, further comprising: scaling the data set over a frequency range that satisfies a bandwidth threshold associated with the sidelink between the receiver UE and the transmitter wireless device.

Aspect 18: The method of any of Aspects 16-17, wherein each repetition is associated with a respective scrambling sequence.

Aspect 19: The method of any of Aspects 16-18, further comprising: performing a scaling estimation procedure using the set of one or more respective sidelink reference signals, wherein scaling the data set according to the one or more parameters is associated with performing the scaling estimation procedure.

Aspect 20: The method of any of Aspects 16-19, further comprising: receiving a set of one or more reference signals; and obtaining the data set from the first set of one or more signals using the set of one or more reference signals.

Aspect 21: The method of any of Aspects 16-20, wherein the second set of one or more signals includes a plurality of frequency domain samples, of the first set of one or more signals, that are generated by the transmitter wireless device.

Aspect 22: The method of Aspect 21, wherein the plurality of frequency domain samples spans a frequency bandwidth that satisfies a bandwidth threshold.

Aspect 23: The method of any of Aspects 16-22, further comprising: transmitting a plurality of repetitions of an additional data set multiplexed with the plurality of repetitions of the data set.

Aspect 24: The method of any of Aspects 16-23, wherein a distance between the receiver UE and the transmitter wireless device is within a distance threshold.

Aspect 25: The method of Aspect 24, further comprising: receiving a resource allocation for communications between wireless communication devices within the distance threshold.

Aspect 26: The method of any of Aspects 24-25, wherein a first resource pool that is associated with wireless communication devices within the distance threshold at least partially overlaps with a second resource pool that is associated with wireless communication devices within a second distance threshold that satisfies a resource reuse distance threshold.

Aspect 27: The method of any of Aspects 16-26, wherein the transmitter wireless device comprises at least one of an auxiliary UE, a wearable UE, a reduced-complexity UE, or a companion device.

Aspect 28: The method of any of Aspects 16-27, wherein the set of one or more respective sidelink reference signals include sidelink demodulation reference signals.

Aspect 29: The method of any of Aspects 16-28, wherein the one or more parameters associated with the sidelink between the receiver UE and the transmitter wireless device includes one or more of: a frequency bandwidth threshold, a reference signal strength indication, a frequency range of the sidelink, a power spectral density threshold, or a channel quality indication.

Aspect 30: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-29.

Aspect 31: An apparatus for wireless communication at a device, the apparatus comprising one or more memories and one or more processors coupled to the one or more memories, which are configured, individually or in any combination to perform the method of one or more of Aspects 1-29.

Aspect 32: An apparatus for wireless communication, the apparatus comprising at least one means for performing the method of one or more of Aspects 1-29.

Aspect 33: A non-transitory computer-readable medium storing code for wireless communication, the code comprising instructions executable by one or more processors to perform the method of one or more of Aspects 1-29.

Aspect 34: A non-transitory computer-readable medium storing a set of instructions for wireless communication, the set of instructions comprising one or more instructions that, when executed by one or more processors of a device, cause the device to perform the method of one or more of Aspects 1-29.

Aspect 35: A device for wireless communication, the device comprising a processing system that includes one or more processors and one or more memories coupled with the one or more processors, the processing system configured to cause the device to perform the method of one or more of Aspects 1-29.

Aspect 36: An apparatus for wireless communication at a device, the apparatus comprising one or more memories and one or more processors coupled to the one or more memories, the one or more processors individually or collectively configured to cause the device to perform the method of one or more of Aspects 1-29.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a receiver user equipment (UE), comprising:
one or more memories; and
one or more processors, coupled to the one or more memories, configured, individually or in any combination, to:
receive, from a network node via an access link, a first set of one or more signals including at least one instance of a data set;
receive, from a transmitter wireless device via a sidelink, a second set of one or more signals including a plurality of repetitions of the data set and including a set of one or more respective sidelink reference signals corresponding to the plurality of repetitions of the data set; and
perform a data processing procedure, according to the set of one or more respective sidelink reference signals, on the first set of one or more signals and the second set of one or more signals to generate the data set.

2. The apparatus of claim 1, wherein the one or more processors, to cause the UE to perform the data processing procedure, are configured, individually or in any combination, to:
perform combined demodulation on the first set of one or more signals and the second set of one or more signals using a set of one or more respective access link reference signals.

3. The apparatus of claim 2, wherein the one or more processors are further configured, individually or in any combination, to:
obtain a first channel estimation that is associated with the first set of one or more signals and a first estimated quantity of samples of the first set of one or more signals; and
obtain a second channel estimation that is associated with the second set of one or more signals and a second estimated quantity of samples of the second set of one or more signals, wherein the combined demodulation is associated with at least one of a first input including the first channel estimation and the first estimated quantity of samples, or a second input including the second channel estimation and the second estimated quantity of samples.

4. The apparatus of claim 2, wherein a quantity of received samples for performing the combined demodulation is associated with a quantity of received samples of the at least one instance of the data set and a quantity of received samples of the plurality of repetitions of the data set.

5. The apparatus of claim 1, wherein the one or more processors, to cause the UE to perform the data processing procedure, are configured to cause the UE to:
identify a set of repetition blocks associated with the plurality of repetitions of the data set; and
perform ratio combining of the set of repetition blocks using the set of one or more respective sidelink reference signals to obtain a combined data set.

6. The apparatus of claim 1, wherein the second set of one or more signals includes a plurality of frequency domain samples, of the first set of one or more signals, that are generated by the transmitter wireless device.

7. The apparatus of claim 6, wherein the plurality of frequency domain samples spans a frequency bandwidth that satisfies a bandwidth threshold.

8. A method of wireless communication performed by a receiver user equipment (UE), comprising:
receiving, from a network node via an access link, a first set of one or more signals including at least one instance of a data set;
receiving, from a transmitter wireless device via a sidelink, a second set of one or more signals including a plurality of repetitions of the data set and including a set of one or more respective sidelink reference signals corresponding to the plurality of repetitions of the data set; and
performing a data processing procedure, according to the set of one or more respective sidelink reference signals, on the first set of one or more signals and the second set of one or more signals to generate the data set.

9. The method of claim 8, wherein performing the data processing procedure comprises:
performing combined demodulation on the first set of one or more signals and the second set of one or more signals using a set of one or more respective access link reference signals.

10. The method of claim 8, further comprising:
receiving a plurality of repetitions of an additional data set multiplexed with the plurality of repetitions of the data set.

11. The method of claim 8, wherein a distance between the receiver UE and the transmitter wireless device is within a distance threshold.

12. The method of claim 11, further comprising:
receiving a resource allocation for communications between wireless communication devices within the distance threshold.

13. The method of claim 11, wherein a first resource pool that is associated with wireless communication devices within the distance threshold at least partially overlaps with a second resource pool that is associated with wireless communication devices within a second distance threshold that satisfies a resource reuse distance threshold.

14. The method of claim 8, wherein the transmitter wireless device comprises at least one of an auxiliary UE, a wearable UE, a reduced-complexity UE, or a companion device.

15. The method of claim 8, further comprising:
receiving a set of one or more access link reference signals corresponding to the at least one instance of the data set.

16. The method of claim 15, wherein performing the data processing procedure comprises:
combining the plurality of repetitions of the data set into a sidelink data set using the set of one or more respective sidelink reference signals; and
performing a second data processing procedure, according to the set of one or more access link reference signals.

17. A non-transitory computer-readable medium storing a set of instructions for wireless communication, the set of instructions comprising:
one or more instructions that, when executed by one or more processors of a receiver user equipment (UE), cause the UE to:
receive, from a network node via an access link, a first set of one or more signals including at least one instance of a data set;
receive, from a transmitter wireless device via a sidelink, a second set of one or more signals including a plurality of repetitions of the data set and including a set of one or more respective sidelink reference signals corresponding to the plurality of repetitions of the data set; and
perform a data processing procedure, according to the set of one or more respective sidelink reference signals, on the first set of one or more signals and the second set of one or more signals to generate the data set.

18. The non-transitory computer-readable medium of claim 17, wherein the one or more instructions, that cause the UE to perform the data processing procedure, cause the UE to:
perform combined demodulation on the first set of one or more signals and the second set of one or more signals using a set of one or more respective access link reference signals.

19. The non-transitory computer-readable medium of claim 18, wherein the one or more instructions further cause the UE to:
obtain a first channel estimation that is associated with the first set of one or more signals and a first estimated quantity of samples of the first set of one or more signals; and
obtain a second channel estimation that is associated with the second set of one or more signals and a second estimated quantity of samples of the second set of one or more signals, wherein the combined demodulation is associated with at least one of a first input including the first channel estimation and the first estimated quantity of samples, or a second input including the second channel estimation and the second estimated quantity of samples.

20. The non-transitory computer-readable medium of claim 17, wherein the set of one or more respective sidelink reference signals include sidelink demodulation reference signals.
